(19) United States
(12) Patent Application Publication
(10) Pub. No.: US 2026/0093278 A1
(43) Pub. Date: Apr. 2, 2026

(54) METHODS AND APPARATUS TO INITIALIZE INTEGRATOR CIRCUITRY WITH AN ALTERNATING CURRENT (AC) SIGNAL

(71) Applicant: Texas Instruments Incorporated, Dallas, TX (US)

(72) Inventor: Ichiro Itoi, Tucson, AZ (US)

(21) Appl. No.: 18/899,728

(22) Filed: Sep. 27, 2024

(51) Int. Cl. G05F 1/12

(52) U.S. Cl. CPC G05F 1/12

(57) ABSTRACT

An example apparatus includes: alternating current (AC) source circuitry having an input and an output; comparator circuitry having an input and an output, the output of the comparator circuitry coupled to the input of the AC source circuitry; integrator circuitry having an output of the integrator circuitry coupled to the input of the comparator circuitry; and a capacitor having a first terminal and a second terminal, the first terminal of the capacitor coupled to the output of the AC source circuitry, the second terminal of the capacitor coupled to the integrator circuitry.

### TECHNICAL FIELD

This description relates generally to integrator circuitry and, more particularly, to methods and apparatus to initialize integrator circuitry with an alternating current (AC) signal.

### BACKGROUND

Current sensing systems use integrator circuitry as a coulomb meter to measure currents. The integrator circuitry accumulates charges of a current at an input and changes an output voltage at a rate that is proportional to the accumulation of charge. The magnitude of the current at the input of the integrator circuitry is equal to the slope of the output voltage times a capacitance of an integrating capacitor. Such current sensing systems use the accumulation of charge over time to accurately measure currents at the input of the integrator circuitry.

### SUMMARY

For methods and apparatus to initialize integrator circuitry with an AC signal, an example apparatus includes AC source circuitry having an input and an output; comparator circuitry having an input and an output, the output of the comparator circuitry coupled to the input of the AC source circuitry; integrator circuitry having an output of the integrator circuitry coupled to the input of the comparator circuitry; and a capacitor having a first terminal and a second terminal, the first terminal of the capacitor coupled to the output of the AC source circuitry, the second terminal of the capacitor coupled to the integrator circuitry. Other examples are described.

For methods and apparatus to initialize integrator circuitry with an AC signal, an example apparatus includes amplifier circuitry having an input and an output; a first diode having a first terminal and a second terminal; a second diode having a first terminal and a second terminal, the first terminal of the second diode coupled to the first terminal of the first diode; a first capacitor having a first terminal and a second terminal, the first terminal of the first capacitor is coupled to the input of the amplifier circuitry, the second terminal of the first diode, and the second terminal of the second diode; and a second capacitor having a terminal coupled to the output of the amplifier circuitry and the second terminal of the first capacitor. Other examples are described.

For methods and apparatus to initialize integrator circuitry with an AC signal, an example apparatus includes amplifier circuitry having an input and an output; a first diode having a first terminal and a second terminal; a second diode having a first terminal and a second terminal; a first capacitor having a first terminal and a second terminal, the first terminal of the first capacitor coupled to the input of the amplifier circuitry, the first terminal of the first diode, and the first terminal of the second diode, the second terminal of the first capacitor coupled to the output of the amplifier circuitry; and a second capacitor having a terminal coupled to the second terminal of the first diode and the second terminal of the second diode. Other examples are described.

For methods and apparatus to initialize integrator circuitry with an AC signal, an example apparatus includes integrator circuitry having an output; a capacitor coupled to the integrator circuitry, the capacitor having a terminal; and comparator circuitry coupled to the output of the integrator circuitry and having an output, the comparator circuitry configured to compare an output voltage of the integrator circuitry to a reference voltage; and alternating current (AC) source circuitry coupled to the integrator circuitry, having an input coupled to the output of the comparator circuitry, and having an output coupled to the terminal of the capacitor, the ac source circuitry configured to provide an AC signal responsive to the comparison of the output voltage to the reference voltage. Other examples are described.

### BRIEF DESCRIPTION OF THE DRAWINGS

FIG. 1 is a block diagram of an example current sense system including example AC compensated sense circuitry.

FIG. 2 is a block diagram of an example of the AC compensated sense circuitry of FIG. 1 including example initialization circuitry.

FIG. 3 is a block diagram of another example of the AC compensated sense circuitry of FIG. 1 including the example initialization circuitry of FIG. 2.

FIG. 4 is a flowchart representative of example machine-readable instructions or example operations that may be at least one of executed, instantiated, or performed using an example implementation of the AC compensated sense circuitry of FIGS. 1, 2, and 3.

FIG. 5 is a schematic diagram of an example of the AC compensated sense circuitry of FIGS. 1 and 2 including example initialization circuitry and example diode circuitry.

FIG. 6 is a schematic diagram of an example of the AC compensated sense circuitry of FIGS. 1 and 3 including another example of the initialization circuitry.

FIG. 7 is a schematic diagram of another example of the AC compensated sense circuitry of FIGS. 1 and 2 including example non-inverting integrator circuitry.

FIG. 8 is a schematic diagram of another example of the AC compensated sense circuitry of FIGS. 1 and 3 including example non-inverting integrator circuitry.

FIG. 9 is a schematic diagram of another example of the AC compensated sense circuitry of FIGS. 1 and 2 including example initialization circuitry and example diode circuitry.

FIG. 10 is a schematic diagram of another example of the AC compensated sense circuitry of FIGS. 1 and 2 including example initialization circuitry and example diode circuitry.

FIG. 11 is a schematic diagram of another example of the AC compensated sense circuitry of FIGS. 1 and 2 including example initialization circuitry and example diode circuitry.

FIG. 12 is a flowchart representative of example machine-readable instructions or example operations that may be at least one of executed, instantiated, or performed using an example implementation of the AC compensated sense circuitry of FIGS. 5, 6, 7, 8, 9, 10, and 11.

FIGS. 13A, 13B, 13C, 13D, and 13E are timing diagrams of example operations of the initialization circuitry of FIGS. 2, 4, 5, 6, and 7 or more generally the AC compensated sense circuitry of FIGS. 2, 5, and 9 using a square waveform with pulse width modulation (PWM).

FIGS. 14A, 14B, 14C, 14D, and 14E are timing diagrams of example operations of the initialization circuitry of FIGS. 2, 4, 5, 6, and 7 or more generally the AC compensated sense circuitry of FIGS. 2, 5, and 9 using another square waveform with PWM.

FIGS. 15A, 15B, 15C, 15D, and 15E are timing diagrams of example operations of the initialization circuitry of FIGS. 2, 4, 5, 6, and 7 or more generally the AC compensated sense circuitry of FIG. 7 using PWM.

FIGS. 16A, 16B, and 16C are timing diagrams of example operations of the initialization circuitry of FIGS. 2, 4, 5, 6, and 7 or more generally the AC compensated sense circuitry of FIGS. 2, 5, 7, and 9 using a triangular waveform.

FIGS. 17A, 17B, and 17C are timing diagrams of example operations of the initialization circuitry of FIGS. 2, 4, 5, 6, and 7 or more generally the AC compensated sense circuitry of FIGS. 2, 5, 7, and 9 using another triangular waveform.

FIGS. 18A, 18B, 18C, and 18D are timing diagrams of example operations of the initialization circuitry of FIGS. 2, 4, 5, 6, and 7 or more generally the AC compensated sense circuitry of FIG. 11 using PWM.

FIGS. 19A, 19B, 19C, and 19D are timing diagrams of example operations of the initialization circuitry of FIGS. 2, 4, 5, 6, and 7 or more generally the AC compensated sense circuitry of FIG. 11 using PWM.

The drawings are not necessarily to scale. Generally, the same reference numbers in the drawing(s) and this description refer to the same or similar (functionally and/or structurally) features and/or parts. Although the drawings show regions with clean lines and boundaries, some or all of these lines and boundaries may be idealized. In reality, the boundaries or lines may be unobservable, blended or irregular.

### DETAILED DESCRIPTION

Current sensing systems use integrator circuitry as a coulomb meter to measure currents. The integrator circuitry accumulates charges of a current at an input and changes an output voltage at a rate that is proportional to the accumulation of charge. The magnitude of the current at the input of the integrator circuitry is equal to the slope of the output voltage times a capacitance of an integrating capacitor. Such current sensing systems use the accumulation of charge over time to accurately measure currents at the input of the integrator circuitry.

Integrator circuitry allows current sense systems to represent magnitudes of currents using a change in voltage over time. Some integrator circuitry includes amplifier circuitry and a capacitor. The amplifier circuitry has a high impedance input and an output. To provide a feedback path, the capacitor is connected between the high impedance input and output of the amplifier circuitry. In current sensing systems, the high impedance input of the amplifier circuitry is coupled to other circuitry to receive the current being measured (i.e., a measurement current). During measurement operations, the measurement current supplies charge to or sinks charge from the high impedance input of the amplifier circuitry. The charge of the measurement current accumulates at the high impedance input of the amplifier circuitry. As charge accumulates at the high impedance input of the amplifier circuitry, the voltage across the capacitor changes at a rate that is proportional to the accumulation. The change in voltage across the capacitor sets the output voltage of the integrator circuitry. In operation, the magnitude of the measurement current is equal to the slope of the output voltage times the capacitance of the capacitor.

However, excess charge accumulation during startup operations of the current sensing system or charge accumulation across extended periods drive the output voltage equal to a supply voltage. When the output voltage is equal to the supply voltage, the amplifier circuitry cannot further increase the output voltage to reflect any further charge accumulation at the high impedance input. Such an output voltage prevents the amplifier circuitry and the capacitor from integrating the accumulation of charge. Therefore, before the integrator circuitry can integrate charges of the measurement current, the accumulated charges of the high-impedance input need to be removed.

One method to remove accumulated charge at the high impedance input of the amplifier circuitry is to create a short across the capacitor, which allows the amplifier circuitry to stabilize. Some current sense circuitry includes relay circuitry coupled across the integrating capacitor. The relay circuitry shorts the capacitor responsive to a reset indication. However, the relay circuitry has a leakage current that contributes to the charge accumulation. The leakage current of the relay circuitry limits the lowest measurable current with the integrator circuitry. Also, performance of the relay circuitry changes across different temperatures and degrades with time. As electronics continue to advance, current sense circuitry needs to support increasingly smaller current measurements across a wide range of operating conditions.

Examples described herein include methods and apparatus to initialize integrator circuitry with an AC signal using AC compensated sense circuitry. In some described examples, the AC compensated sense circuitry includes integrator circuitry, diode circuitry, a coupling capacitor, and initialization circuitry. The integrator circuitry includes amplifier circuitry and capacitor circuitry that are structured to integrate charge accumulation at a high impedance input of the AC compensated sense circuitry. The diode circuitry includes a first diode and a second diode. The first and second diodes couple the high impedance input of the AC compensated sense circuitry to a common terminal, which supplies a ground voltage. The anode of the first diode is coupled to the cathode of the second diode and the cathode of the first diode is coupled to the anode of the second diode. Such a structure of the first and second diodes may be referred to as back-to-back diodes. In some examples, the coupling capacitor is coupled to the output of guard buffer amplifier circuitry and the capacitor of the integrator circuitry. The initialization circuitry is coupled to the integrator circuitry by the coupling capacitor. In other examples, the coupling capacitor is coupled to the integrator circuitry by the diode circuitry. In such examples, the initialization circuitry is coupled to the diode circuitry by the coupling capacitor.

In example operation, the initialization circuitry supplies an AC signal responsive to at least one of a reset indication or detecting a saturation of the output voltage. The reset indication is a signal from external circuitry to reset the accumulated charge. The initialization circuitry includes comparator circuitry. The comparator circuitry detects saturation of the output voltage responsive to a comparison of the output voltage to reference voltages. In some examples, the reference voltages of the comparator circuitry are high and low side supply voltages. The comparator circuitry determines saturation of the output voltage as the output voltage approaches the reference voltages. Accordingly, the high and low side supply voltages set a maximum and minimum output voltage of the integrator circuitry.

In such example operations, the coupling capacitor filters direct current bias and creates a voltage difference across the diode circuitry, which causes at least one of the first or second diodes to conduct current. The AC signal drives charge to or from the high impedance input of the AC compensated sense circuitry, which removes positive charge accumulation or negative charge accumulation. Advantageously, the AC signal creates a voltage difference across the first and second diodes and between the high impedance input and the ground voltage to reduce charge accumulation.

In some examples, the AC signal allows the AC compensated sense circuitry to start integration operations at a non-zero output voltage. In such examples, the non-zero output voltage allows the AC compensated sense circuitry to account for dielectric relaxation responsive to having a zero crossing when supplying the AC signal. For example, the dielectric relaxation begins to compound as the output voltage increases responsive to the derivative of the output voltage compounding as a leakage current. However, the leakage current across the integration capacitor is substantially smaller when the output voltage is near zero. Advantageously, the zero crossing during integration facilitates the voltage difference across the integrating capacitor crossing zero volts. Advantageously, setting the voltage across the integrating capacitor to zero reduces the leakage current, which reduces measurement errors resulting from dielectric relaxation.

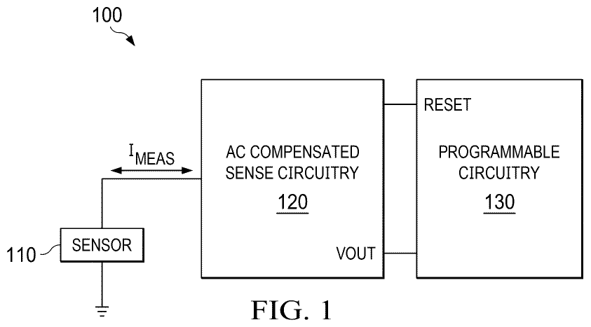

FIG. 1 is a block diagram of an example current sense system 100. In the example of FIG. 1, the current sense system 100 includes a sensor 110, AC compensated sense circuitry 120, and programmable circuitry 130. The sensor 110 has a first terminal and a second terminal. The first terminal of the sensor 110 is coupled to the AC compensated sense circuitry 120. The second terminal of the sensor 110 is coupled to a common terminal, which supplies a common potential (e.g., a ground voltage, AVSS, etc.). In some examples, the sensor 110 is a photo sensor, a piezo sensor, a PH sensor, a gas chromatography device, insulation measurement device, resistivity measurement device, etc.

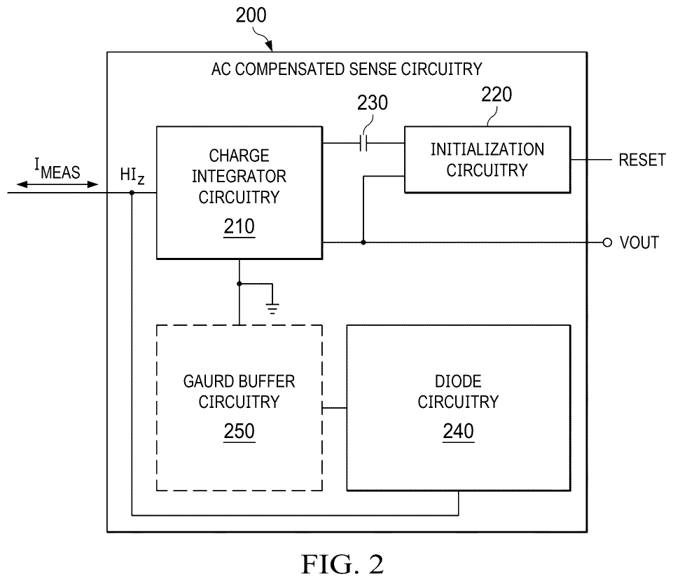

The AC compensated sense circuitry 120 has a first terminal, a second terminal, and a third terminal. The first terminal of the AC compensated sense circuitry 120 is coupled to the sensor 110. The second and third terminals of the AC compensated sense circuitry 120 are coupled to the programmable circuitry 130. Examples of the AC compensated sense circuitry 120 are illustrated and described in connection with FIGS. 2, 4, 5, 6, and 7, below.

The programmable circuitry 130 has a first terminal and a second terminal. The first and second terminals of the programmable circuitry 130 are coupled to the AC compensated sense circuitry 120. In some examples, the programmable circuitry 130 is illustrated or described as a central processing unit (CPU), graphics processing unit (GPU), microcontroller, etc. In such examples, the programmable circuitry 130 is structured to instantiate circuitry responsive to an execution of machine-readable instructions.

In example operation, during startup of the current sense system 100, the programmable circuitry 130 generates a reset indication (RESET). The reset indication represents a control signal to the AC compensated sense circuitry 120 to perform operations to remove charge accumulation at the high impedance input of the AC compensated sense circuitry 120. The AC compensated sense circuitry 120 generates an AC signal to remove the charge accumulation at the high impedance input. Example operations of the AC compensated sense circuitry 120 to remove charge accumulation responsive to the reset indication are further illustrated and described below.

In example operations, the sensor 110 is structured to generate a measurement current (I_{MEAS}) responsive to at least one of sensing, detecting, measuring, or setting an observable property. For example, when the sensor is a photo sensor, the sensor 110 produces the measurement current based on a pressure applied to the sensor 110. The sensor 110 supplies or removes charges from the high impedance input of the AC compensated sense circuitry 120 at a rate proportional to the magnitude of the measurement current. The AC compensated sense circuitry 120 generates an output voltage responsive to the accumulation of charge at the high impedance input. Example operations of the AC compensated sense circuitry 120 are further illustrated and described below. The programmable circuitry 130 determines a slope of the output voltage. The programmable circuitry 130 determines the value of the measurement current responsive to dividing the determined slope by the capacitance of the integrating capacitor of the AC compensated sense circuitry 120. Such capacitance is illustrated and described further below.

FIG. 2 is a block diagram of example AC compensated sense circuitry 200, which is an example of the AC compensated sense circuitry 120. In the example of FIG. 2, the AC compensated sense circuitry 200 includes charge integrator circuitry 210, initialization circuitry 220, a capacitor 230, and diode circuitry 240. Some examples of the AC compensated sense circuitry 200 include guard buffer circuitry 250. The AC compensated sense circuitry 200 has a first input, a second input, and an output. The first input of the AC compensated sense circuitry 200 (also referred to as a high impedance input (HI_{Z})) is structured to be coupled to the sensor 110, which supplies or sinks a measurement current (I_{MEAS}). The second input of the AC compensated sense circuitry 200 is structured to be coupled to the programmable circuitry 130, which supplies a reset indication (RESET). The output of the AC compensated sense circuitry 200 is structured to be coupled to the programmable circuitry 130, which receives an output voltage (VOUT).

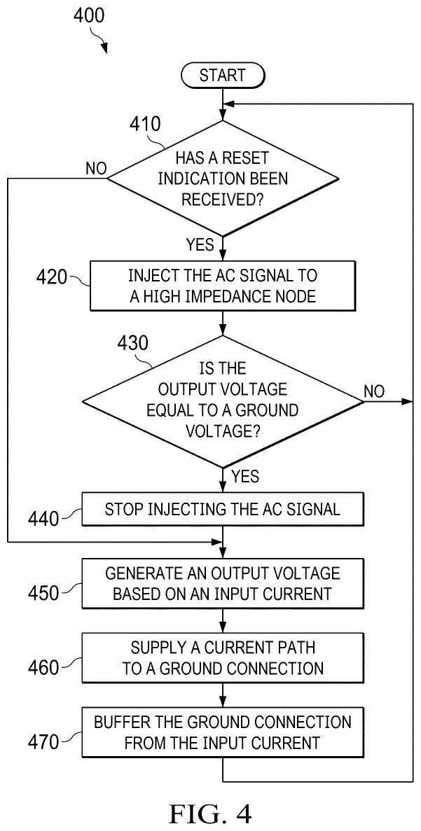

The charge integrator circuitry 210 (also referred to as integrator circuitry) has a first terminal, a second terminal, a third terminal, and a fourth terminal. The first terminal of the charge integrator circuitry 210 is coupled to the diode circuitry 240 and the first input of the AC compensated sense circuitry 200, which supplies the measurement current. The second terminal of the charge integrator circuitry 210 is coupled to the guard buffer circuitry 250 and the common terminal, which supplies the common potential. The third terminal of the charge integrator circuitry 210 is coupled to the capacitor 230. The fourth terminal of the charge integrator circuitry 210 is coupled to the initialization circuitry 220 and the output of the AC compensated sense circuitry 200. Examples of the charge integrator circuitry 210 is illustrated and described in connection with FIGS. 4, 5, 6, and 7, below.

The initialization circuitry 220 has a first terminal, a second terminal, and a third terminal. The first terminal of the initialization circuitry 220 is coupled to the capacitor 230. The second terminal of the initialization circuitry 220 is coupled to the second input of the AC compensated sense circuitry 200, which supplies the reset indication. The third terminal of the initialization circuitry 220 is coupled to the charge integrator circuitry 210 and the output of the AC compensated sense circuitry 200. An example of the initialization circuitry 220 is illustrated and described in connection with FIGS. 4, 5, 6, and 7, below.

The capacitor 230 has a first terminal and a second terminal. The first terminal of the capacitor 230 is coupled to the charge integrator circuitry 210. The second terminal of the capacitor 230 is coupled to the initialization circuitry 220. In some examples, the capacitor 230 is referred to as a coupling capacitor. Example implementations of the capacitor 230 are illustrated and described in connection with FIGS. 4, 5, 6, and 7, below.

The diode circuitry 240 has a first terminal and a second terminal. The first terminal of the diode circuitry 240 is coupled to the charge integrator circuitry 210 and the first input of the AC compensated sense circuitry 200, which supplies the measurement current. The second terminal of the diode circuitry 240 is coupled to the guard buffer circuitry 250. Examples of the diode circuitry 240 are illustrated and described in connection with FIGS. 4, 5, 6, and 7, below.

The guard buffer circuitry 250 has a first terminal and a second terminal. The first terminal of the guard buffer circuitry 250 is coupled to the charge integrator circuitry 210 and the common terminal, which supplies the common potential. The second terminal of the guard buffer circuitry 250 is coupled to the diode circuitry 240. An example of the guard buffer circuitry 250 is illustrated and described in connection with FIGS. 4, 5, 6, and 7, below.

In some examples, the AC compensated sense circuitry 200 is a single integrated circuit (IC) (such as circuitry implemented on a single semiconductor die or on multiple die but within a single IC package). For example, the charge integrator circuitry 210, the initialization circuitry 220, the capacitor 230, the diode circuitry 240, and the guard buffer circuitry 250 may be included on the same semiconductor die. In some examples, the AC compensated sense circuitry 200 may be implemented by two or more ICs in a single IC package to implement a multi-chip module (MCM). In some examples, the AC compensated sense circuitry 200 may be implemented by two or more ICs (such as two or more IC packages). For example, the charge integrator circuitry 210, the capacitor 230, the diode circuitry 240, and the guard buffer circuitry 250 may be on a first die and the initialization circuitry 220 may be on a second die. In some examples, the charge integrator circuitry 210 may be on a first die, the initialization circuitry 220 may be on a second die, and the capacitor 230, the diode circuitry 240, and the guard buffer circuitry 250 may be on a third die.

In example operations, the capacitor 230 supplies AC signals from the initialization circuitry 220 to the charge integrator circuitry 210, which drives current to or from the buffered ground of the guard buffer circuitry 250 through the diode circuitry 240. In the example of FIG. 2, the AC signals produce a voltage difference between the ground voltage of the diode circuitry 240 and the high impedance input of the AC compensated sense circuitry 200, which drives current through the diode circuitry 240. For example, during positive portions of the AC signal, the voltage difference between the high impedance input of the AC compensated sense circuitry 200 and the ground voltage biases the diode circuitry to sink current. Similarly, during negative portions of the AC signal, the voltage difference between the high impedance input of the AC compensated sense circuitry 200 and the ground voltage biases the diode circuitry to supply current. In such examples, the voltage swings of the AC signals correspond to the direction of the conduction of charge. Further example operations of the AC compensated sense circuitry 200 are further illustrated and described in connection with FIG. 4, below.

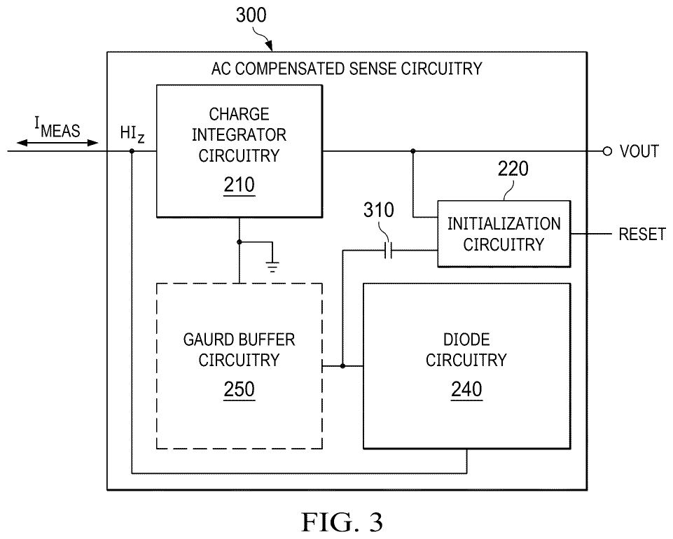

FIG. 3 is a schematic diagram of example AC compensated sense circuitry 300, which is an example of the AC compensated sense circuitry 120 of FIG. 1. In the example of FIG. 3, the AC compensated sense circuitry 300 includes the charge integrator circuitry 210, the initialization circuitry 220, the diode circuitry 240, the guard buffer circuitry 250, and a capacitor 310.

The AC compensated sense circuitry 300 has a first input, a second input, and an output. The first input of the AC compensated sense circuitry 300 (also referred to as the high impedance input (HI_{Z})) is structured to be coupled to the sensor 110, which supplies or sinks a measurement current (I_{MEAS}). The second input of the AC compensated sense circuitry 300 is structured to be coupled to the programmable circuitry 130, which supplies a reset indication (RESET). The output of the AC compensated sense circuitry 300 is structured to be coupled to the programmable circuitry 130.

The capacitor 310 has a first terminal and a second terminal. The first terminal of the capacitor 310 is coupled to the initialization circuitry 220. The second terminal of the capacitor 310 is coupled to the diode circuitry 240. In some examples, the capacitor 310 is referred to as a coupling capacitor.

In some examples, the AC compensated sense circuitry 300 is a single integrated circuit (IC) (such as circuitry implemented on a single semiconductor die or on multiple die but within a single IC package). For example, the charge integrator circuitry 210, the initialization circuitry 220, the diode circuitry 240, the guard buffer circuitry 250, and the capacitor 310 may be included on the same semiconductor die. In some examples, the AC compensated sense circuitry 300 may be implemented by two or more ICs in a single IC package to implement a multi-chip module (MCM). In some examples, the AC compensated sense circuitry 300 may be implemented by two or more ICs (such as two or more IC packages). For example, the charge integrator circuitry 210, the diode circuitry 240, the guard buffer circuitry 250, and the capacitor 310 may be on a first die and the initialization circuitry 220 may be on a second die. In some examples, the charge integrator circuitry 210 may be on a first die, the initialization circuitry 220 may be on a second die, and the diode circuitry 240, the guard buffer circuitry 250, and the capacitor 310 may be on a third die.

In example operations, the capacitor 310 supplies AC signals from the initialization circuitry 220 to the buffered ground from the guard buffer circuitry 250. Unlike in the examples of FIG. 2, the AC signals drive the ground voltage of the diode circuitry 240. In such examples, the voltage swings of the AC signals correspond to a conduction of charge in an opposite direction opposed to the structure of the AC compensated sense circuitry 200. Further example operations of the AC compensated sense circuitry 300 are further illustrated and described in connection with FIG. 4, below.

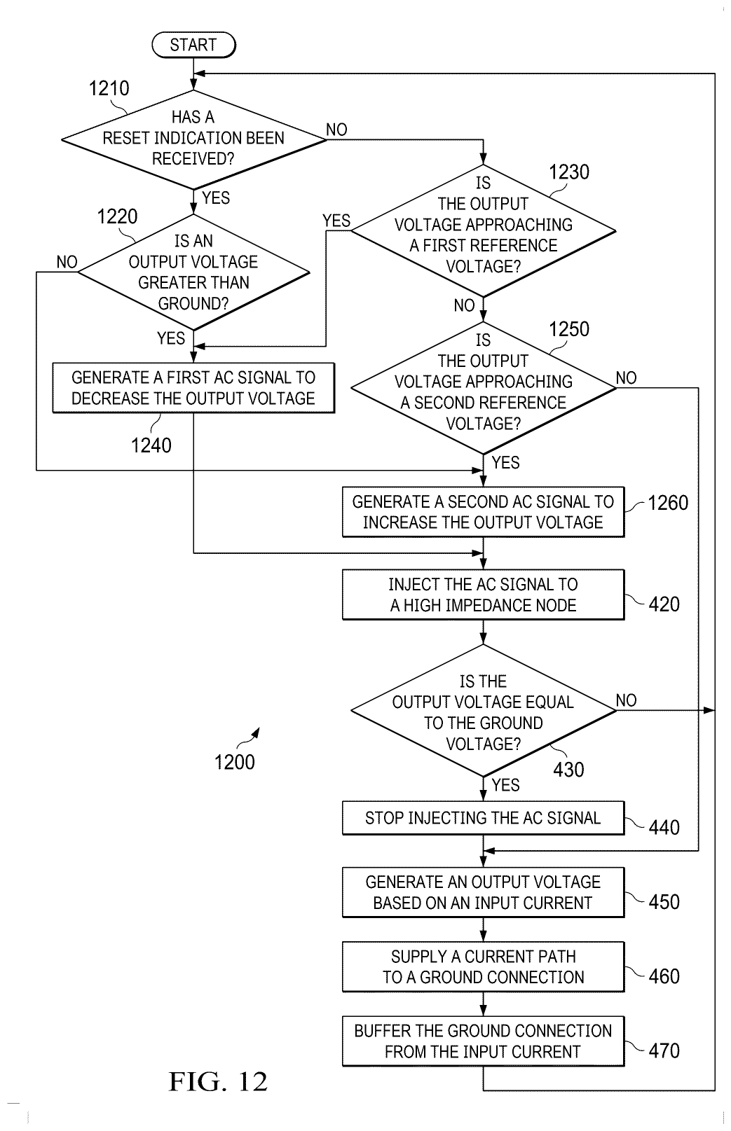

FIG. 4 is a flowchart representative of example machine-readable instructions or example operations 400 that may be at least one of executed, instantiated, or performed using an example implementation of the AC compensated sense circuitry 120, 200, 300. The example operations 400 of FIG. 4 begin at Block 410 at which the initialization circuitry 220 determines if a reset indication has been received. In example operations, the programmable circuitry 130 detects that the output voltage of the AC compensated sense circuitry 120, 200, 300 is at a maximum or minimum voltage. In such examples, the programmable circuitry 130 sets a provides indication responsive to a determination that the output voltage of the AC compensated sense circuitry 120, 200, 300 is at the maximum or minimum voltage. The reset indication represents a determination that an accumulation of charge at the first input of the AC compensated sense circuitry 120 is saturating the output voltage at a supply voltage (e.g., the maximum or minimum voltage). When saturated, the output of the AC compensated sense circuitry 120 fails to accurately represent the measurement current responsive to charge accumulation at the first input of the AC compensated sense circuitry 120. In such example operations, the initialization circuitry 220 receives the reset indication from the programmable circuitry 130. In other examples, as illustrated and described in connection with FIG. 12, below, the initialization circuitry 220 may include circuitry to detect saturation of the output voltage.

If the initialization circuitry 220 determines that a reset indication has been received (e.g., Block 410 returns a result of YES), the capacitors 230, 310 inject an AC signal to a high impedance node (HI_{Z}). (Block 420). In example operations, the initialization circuitry 220 generates an AC signal responsive to receiving the reset indication. In some examples, such as in FIG. 2, the capacitor 230 supplies the AC signal to the charge integrator circuitry 210. In such examples, AC portions of the AC signal propagate through the capacitor 230 and the charge integrator circuitry 210 to set the voltage at the high impedance first input of the AC compensated sense circuitry 200. Advantageously, the charge integrator circuitry 210 creates a potential difference between the high impedance input of the AC compensated sense circuitry 200 and the ground voltage responsive to an AC signal from the capacitor 210.

In some other examples, such as in FIG. 3, the capacitor 310 supplies the AC signal to the diode circuitry 240 and the guard buffer circuitry 250. In such examples, the AC portions of the AC signal propagate through the capacitor 310 to set the voltage of the buffered ground from the guard buffer circuitry 250. Advantageously, the capacitor 310 creates a potential difference between the ground voltage and the high impedance input of the AC compensated sense circuitry 200 by driving the buffered ground voltage.

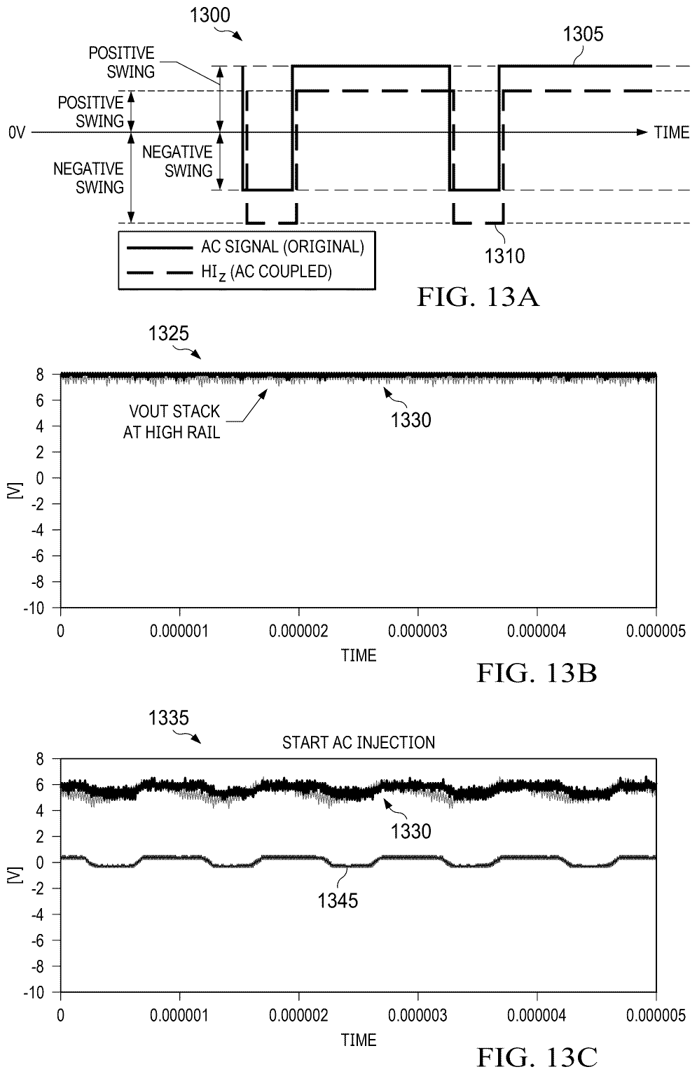

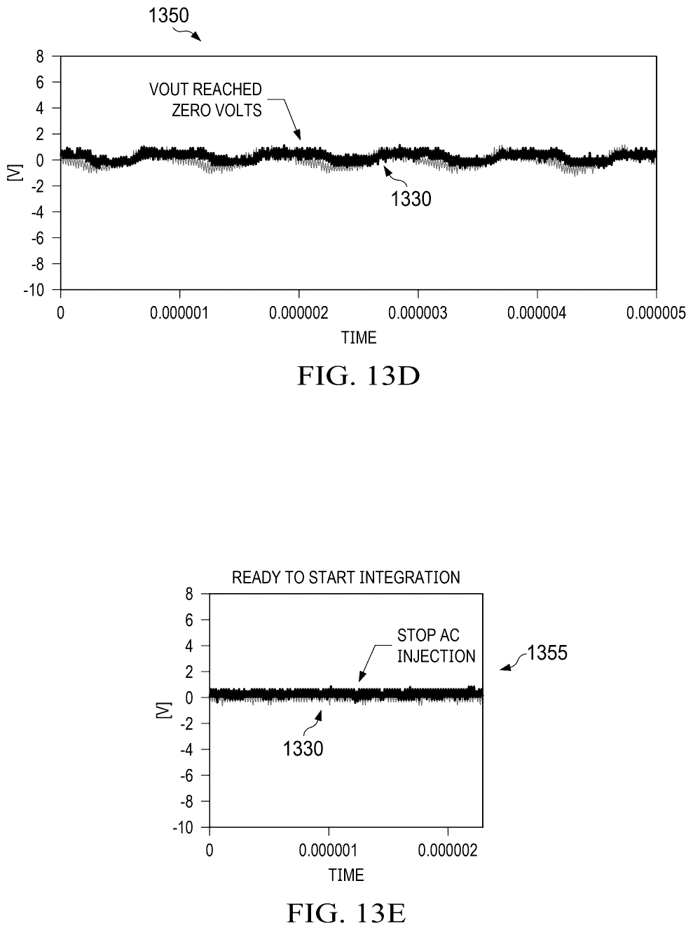

In both such example operations, the AC signal increases or decreases accumulated charges responsive to driving current to or from the first input of the AC compensated sense circuitry 200. Advantageously, injecting the AC signal by the initialization circuitry 220 and the capacitors 230, 310 reduces dielectric absorption by controlling charges at the high impedance input. Examples of the AC signals are further illustrated and described in connection with FIGS. 13A, 14A, 15A, 16A, and 17A, below.

The initialization circuitry 220 determines if the output voltage is equal to a desired voltage. (Block 430). In example operations, the initialization circuitry 220 compares the output voltage of the AC compensated sense circuitry 200 to a desired voltage (e.g. the common potential). In some examples, the initialization circuitry 220 determines the presence of accumulated charges at the first input of the AC compensated sense circuitry 200 responsive to a difference between the desired voltage and the output voltage. For example, the initialization circuitry 220 determines the presence of positive charge accumulation responsive to the output voltage being greater than the desired voltage. In such examples, the initialization circuitry 220 determines the presence of negative charge accumulation responsive to the output voltage being less than the desired voltage. In such example operations, the initialization circuitry 220 determines a lack of charge accumulation responsive to the output voltage being approximately equal to the desired voltage. If the initialization circuitry 220 determines that the output voltage is not equal to the desired voltage (e.g., Block 430 returns a result of NO), control proceeds to return to Block 410.

If the initialization circuitry 220 determines that the output voltage is equal to the desired voltage (e.g., Block 430 returns a result of YES), the capacitor 230 stops injecting the AC signal. (Block 440). In example operations, the initialization circuitry 220 stops generating the AC signal responsive to a determination that the output voltage is equal to the desired voltage. In such example operations, the initialization circuitry 220 and the capacitor 230 allow charges of the measurement current to drive the first input of the AC compensated sense circuitry 120, 200, 300.

The charge integrator circuitry 210 generates an output voltage based on an input current. (Block 450). In example operations, the charge integrator circuitry 210 adjusts the output voltage of the AC compensated sense circuitry 120, 200, 300 responsive to an integration of charges of the measurement current. For example, the AC compensated sense circuitry 120, 200, 300 increases the output voltage responsive to the measurement current having a positive magnitude. Also, the change in output of the charge integrator circuitry 210 is proportional to the magnitude of the measurement current. Advantageously, the charge integrator circuitry 210 changes the output voltage of the AC compensated sense circuitry 120, 200, 300 based on the measurement current.

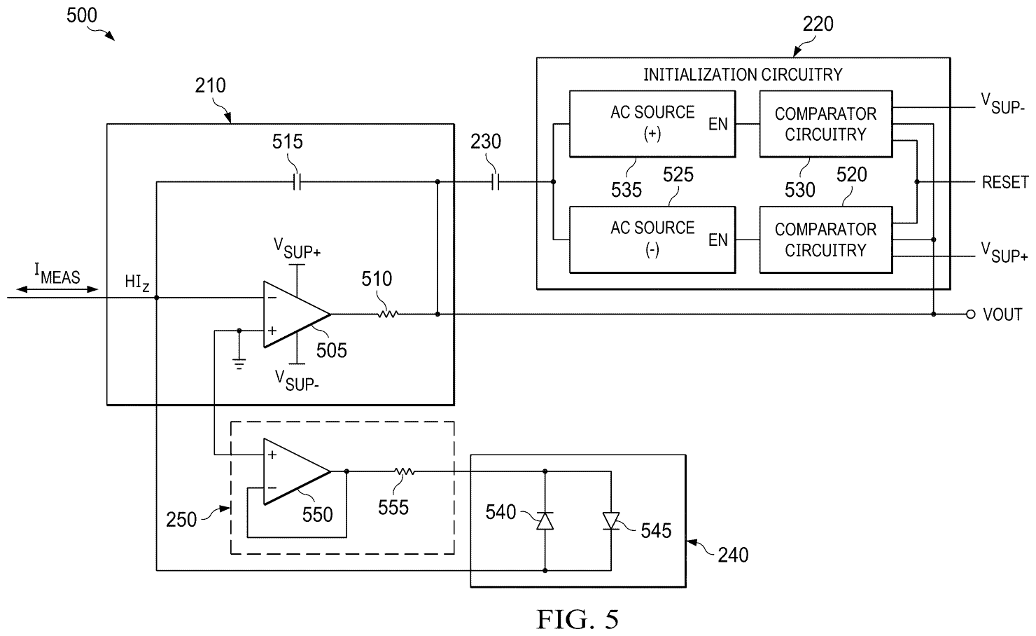

The diode circuitry 240 supplies a current path to a ground connection. (Block 460). In some examples, the charge integrator circuitry 210 includes circuitry to set the first input of the AC compensated sense circuitry 200 to a high impedance. Such an example is illustrated and described in connection with FIGS. 5, 6, 7, 8, 9, 10, and 11, below. In such examples, the diode circuitry 240 clamps an output of the guard buffer circuitry 250 to the voltage at the first input of the AC compensated sense circuitry 200 and provides electrostatic discharge protection. For example, the diode circuitry 240 prevents excessive currents from generating relatively high voltage transients at the input of the charge integrator circuitry 210. In example operations, the current-voltage (I-V) characteristics of the diode circuitry 240 allow the AC signal to use positive and negative voltage swings to modify charge accumulated by the measurement current. Such example operations are further described in connection with FIGS. 13A, 14A, 15A, 16A, and 17A, below.

The guard buffer circuitry 250 buffers a reference voltage at a reference node to the high impedance node. (Block 470). In some examples, the guard buffer circuitry 250 isolates a ground voltage from the diode circuitry 240. In such examples, the output of the charge integrator circuitry 210 is responsive to the differential voltage between the high impedance input of the AC compensated sense circuitry 120, 200, 300 and the ground voltage at the reference node. In example operations, the guard buffer circuitry 250 prevents current into the high impedance input of the AC compensated sense circuitry 200 from any other nodes that have voltage difference to the high impedance input. Advantageously, the guard buffer circuitry 250 prevents currents from the diode circuitry 240 from effecting operations of other components coupled to the common terminal, such as the charge integrator circuitry 210.

Example methods are described with reference to the flowchart illustrated in FIG. 4. However, many other methods of implementing the AC compensated sense circuitry 120, 200, 300 may also be used in this description, such as in FIG. 12. For example, the order of execution of the blocks may be changed, or some of the blocks described may be changed, eliminated, or combined. Similarly, additional operations may be included in the manufacturing process before, in between, or after the blocks shown in the illustrated examples.

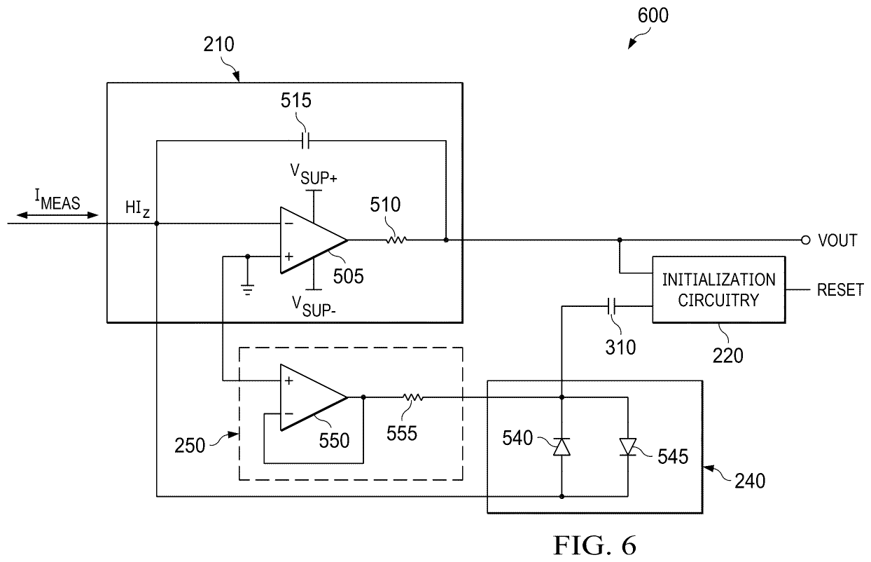

FIG. 5 is a schematic diagram of example AC compensated sense circuitry 500, which is an example of the AC compensated sense circuitry 120, 200. In the example of FIG. 5, the AC compensated sense circuitry 500 includes the charge integrator circuitry 210, the initialization circuitry 220, the capacitor 230, the diode circuitry 240, and the guard buffer circuitry 250. The example charge integrator circuitry 210 of FIG. 5 includes example amplifier circuitry 505, an example resistor 510, and an example capacitor 515. The example initialization circuitry 220 of FIG. 5 includes first example comparator circuitry 520, first example AC source circuitry 525, second example comparator circuitry 530, and second example AC source circuitry 535. The particular implementation of the initialization circuitry 220 shown in FIG. 5 may also be implemented in the example initialization circuitry 220 of FIGS. 6-11. The example diode circuitry 240 includes a first example diode 540 and a second example diode 545. The example guard buffer circuitry 250 of FIG. 5 includes an example amplifier circuitry 550 and an example resistor 555.

The AC compensated sense circuitry 500 has a first input, a second input, and an output. The first input of the AC compensated sense circuitry 500 (also referred to as the high-impedance input (HI_{Z})) is structured to be coupled to the sensor 110, which supplies or sinks a measurement current (I_{MEAS}). The second input of the AC compensated sense circuitry 500 is structured to be coupled to the programmable circuitry 130, which supplies a reset indication (RESET). The output of the AC compensated sense circuitry 500 is structured to be coupled to the programmable circuitry 130, which receives an output voltage (VOUT).

The amplifier circuitry 505 has a first input, a second input, a first supply terminal, a second supply terminal, and an output. The first input of the amplifier circuitry 505 is coupled to the diode circuitry 240, the capacitor 515, and the first input of the AC compensated sense circuitry 200, which supplies the measurement current. The second input of the amplifier circuitry 505 is coupled to the guard buffer circuitry 250 and the common terminal, which supplies the common potential. The first supply terminal of the amplifier circuitry 505 is coupled to a high-side supply terminal, which supplies a high-side supply voltage (V_{SUP+}). In some examples, the high-side supply voltage represents a maximum output voltage of the amplifier 505. The second supply terminal of the amplifier circuitry 505 is coupled to a low-side supply terminal, which supplies a low-side supply voltage (V_{SUP-}). In some examples, the low-side supply voltage represents a minimum output voltage of the amplifier 505. The output of the amplifier circuitry 505 is coupled to the resistor 510.

The resistor 510 has a first terminal and a second terminal. The first terminal of the resistor 510 is coupled to the amplifier circuitry 505. The second terminal of the resistor 510 is coupled to the initialization circuitry 220, the capacitors 230, 515, and the output of the AC compensated sense circuitry 500.

The capacitor 515 has a first terminal and a second terminal. The first terminal of the capacitor 515 is coupled to the diode circuitry 240, the amplifier circuitry 505, and the first input of the AC compensated sense circuitry 500, which supplies the measurement current. The second terminal of the capacitor 515 is coupled to the initialization circuitry 220, the capacitor 230, the resistor 510, and the output of the AC compensated sense circuitry 500.

The comparator circuitry 520 has a first terminal, a second terminal, a third terminal, and a fourth terminal. The first terminal of the comparator circuitry 520 is coupled to the comparator circuitry 530 and the second input of the AC compensated sense circuitry 500, which supplies the reset indication. The second terminal of the comparator circuitry 520 is coupled to the charge integrator circuitry 210, the comparator circuitry 530, and the output of the AC compensated sense circuitry 500. The third terminal of the comparator circuitry 520 is coupled to the high-side supply terminal, which supplies the high-side supply voltage or user defined voltage. The fourth terminal of the comparator circuitry 520 is coupled to the AC source circuitry 525.

The AC source circuitry 525 has a first terminal and a second terminal. The first terminal of the AC source circuitry 525 is coupled to the comparator circuitry 520. The second terminal of the AC source circuitry 525 is coupled to the capacitor 230 and the AC source circuitry 535.

The comparator circuitry 530 has a first terminal, a second terminal, a third terminal, and a fourth terminal. The first terminal of the comparator circuitry 530 is coupled to the comparator circuitry 520 and the second input of the AC compensated sense circuitry 500, which supplies the reset indication. The second terminal of the comparator circuitry 530 is coupled to the charge integrator circuitry 210, the comparator circuitry 520, and the output of the AC compensated sense circuitry 500. The third terminal of the comparator circuitry 530 is coupled to the low-side supply terminal, which supplies the low-side supply voltage or user defined voltage. The fourth terminal of the comparator circuitry 530 is coupled to the AC source circuitry 535.

The AC source circuitry 535 has a first terminal and a second terminal. The first terminal of the AC source circuitry 535 is coupled to the comparator circuitry 530. The second terminal of the AC source circuitry 535 is coupled to the capacitor 230 and the AC source circuitry 525. In some examples, the comparator circuitry 520, 530 may be illustrated and described using one or more additional comparators. In such examples, the initialization circuitry 220 may further include additional instances of one or both of the AC source circuitry 525, 535.

The diode 540 has a first terminal and a second terminal. The first terminal of the diode 540 is coupled to the charge integrator circuitry 210, the diode 545, and the first input of the AC compensated sense circuitry 500, which supplies the measurement current. The second terminal of the diode 540 is coupled to the guard buffer circuitry 250 and the diode 545.

The diode 545 has a first terminal and a second terminal. The first terminal of the diode 545 is coupled to the charge integrator circuitry 210, the diode 540, and the first input of the AC compensated sense circuitry 500, which supplies the measurement current. The second terminal of the diode 545 is coupled to the guard buffer circuitry 250 and the diode 540. In the example of FIG. 5, the diodes 540, 545 are structured as back-to-back diodes.

The amplifier circuitry 550 has a first input, a second input, and an output. The first input of the amplifier circuitry 550 is coupled to the charge integrator circuitry 210 and the common terminal, which supplies the common potential. The second input and the output of the amplifier circuitry 550 is coupled to the resistor 555.

The resistor 555 has a first terminal and a second terminal. The first terminal of the resistor 555 is coupled to the amplifier circuitry 550. The second terminal of the resistor 555 is coupled to the diode circuitry 240.

FIG. 6 is a schematic diagram of example AC compensated sense circuitry 600, which is an example of the AC compensated sense circuitry 120 and 300. In the example of FIG. 6, the AC compensated sense circuitry 600 includes the charge integrator circuitry 210, the initialization circuitry 220, the diode circuitry 240, the guard buffer circuitry 250, and the capacitor 310. The example charge integrator circuitry 210 of FIG. 6 includes the amplifier circuitry 505, the resistor 510, and the capacitor 515. The example diode circuitry 240 of FIG. 6 includes the diodes 540, 545. The example guard buffer circuitry 250 of FIG. 6 includes the amplifier circuitry 550.

The AC compensated sense circuitry 600 has a first input, a second input, and an output. The first input of the AC compensated sense circuitry 600 (also referred to as the high impedance input (HI_{Z})) is structured to be coupled to the sensor 110, which supplies or sinks a measurement current (I_{MEAS}). The second input of the AC compensated sense circuitry 600 is structured to be coupled to the programmable circuitry 130, which supplies a reset indication (RESET). The output of the AC compensated sense circuitry 600 is structured to be coupled to the programmable circuitry 130.

In example operations, the capacitor 310 supplies AC signals from the initialization circuitry 220 to the buffered ground from the guard buffer circuitry 250. Unlike in the examples of FIGS. 2 and 5, the AC signals drive the ground voltage of the diodes 540, 545. In such examples, the voltage swings of the AC signals correspond to a conduction by the opposite one of the diodes 540, 545. For example, in FIGS. 2 and 5, the capacitors 230, 515 supply AC signals to the high impedance input of the AC compensated sense circuitry 200, 500, which is coupled to the anode of the diode 540 and the cathode of the diode 545. However, in FIG. 6, the capacitor 310 supplies AC signals to the cathode of the diode 540 and the anode of the diode 545. In the example of FIG. 6, positive voltage swings of AC signals control the current conduction of the diode 545 and negative voltage swings of AC signals control the current conduction of the diode 540. Advantageously, the initialization circuitry 220 may be structured to inject AC signals to either side of the diode circuitry 240.

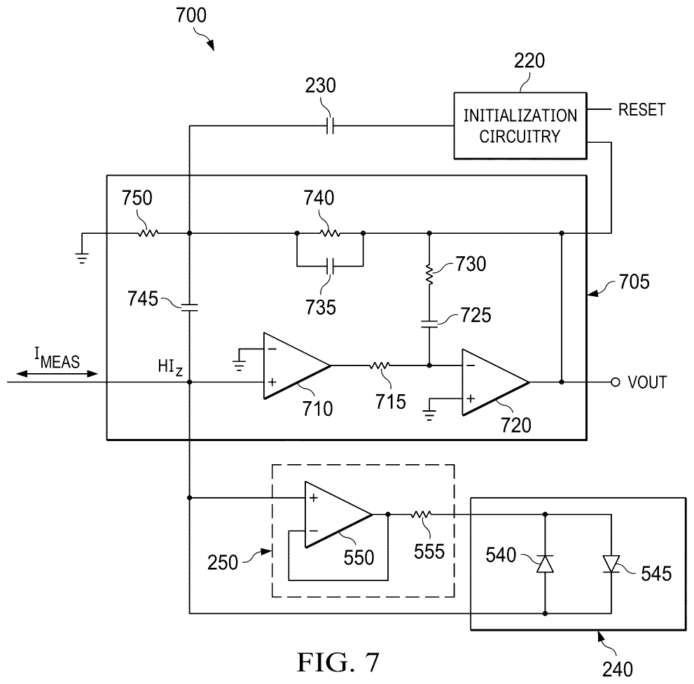

FIG. 7 is a schematic diagram of example AC compensated sense circuitry 700, which is an example of the AC compensated sense circuitry 120 and 200. In the example of FIG. 7, the AC compensated sense circuitry 700 includes the initialization circuitry 220, the capacitor 230, the diode circuitry 240, the guard buffer circuitry 250, and example charge integrator circuitry 705. The example diode circuitry 240 of FIG. 7 includes the diodes 540, 545. The example guard buffer circuitry 250 of FIG. 7 includes the amplifier circuitry 550 and the resistor 555. The example charge integrator circuitry 705 of FIG. 7 includes a first example amplifier circuitry 710, a first example resistor 715, a second example amplifier circuitry 720, a first example capacitor 725, a second example resistor 730, a second example capacitor 735, a third example resistor 740, a third example capacitor 745, and a fourth example resistor 750.

The AC compensated sense circuitry 700 has a first input, a second input, and an output. The first input of the AC compensated sense circuitry 700 (also referred to as the high impedance input (HI_{Z})) is structured to be coupled to the sensor 110, which supplies or sinks a measurement current (I_{MEAS}). Unlike the examples of FIGS. 5 and 6, the high impedance input of the AC compensated sense circuitry 700 is a non-inverting input of the amplifier circuitry 710. The second input of the AC compensated sense circuitry 700 is structured to be coupled to the programmable circuitry 130, which supplies a reset indication (RESET). The output of the AC compensated sense circuitry 700 is structured to be coupled to the programmable circuitry 130.

The charge integrator circuitry 705 has a first terminal, a second terminal, a third terminal, and a fourth terminal. The first terminal of the charge integrator circuitry 705 is coupled to the diode circuitry 240, the guard buffer circuitry 250, and the first input of the AC compensated sense circuitry 700, which supplies the measurement current. The second terminal of the charge integrator circuitry 705 is coupled to the initialization circuitry 220 and the output of the AC compensated sense circuitry 700. The third terminal of the charge integrator circuitry 705 is coupled to the capacitor 230. The fourth terminal of the charge integrator circuitry 705 is coupled to the common terminal, which supplies the common potential.

The amplifier circuitry 710 has a first input, a second input, and an output. The first input of the amplifier circuitry 710 is coupled to the diode circuitry 240, the guard buffer circuitry 250, the capacitor 745, and the first input of the AC compensation sense circuitry 700, which supplies the measurement current. The second input of the amplifier circuitry 710 is coupled to the common terminal, which supplies the common potential. The output of the amplifier circuitry 710 is coupled to the resistor 715.

The resistor 715 has a first terminal and a second terminal. The first terminal of the resistor 715 is coupled to the amplifier circuitry 710. The second terminal of the resistor 715 is coupled to the amplifier circuitry 720 and the capacitor 725.

The amplifier circuitry 720 has a first input, a second input, and an output. The first input of the amplifier circuitry 720 is coupled to the resistor 715 and the capacitor 725. The second input of the amplifier circuitry 720 is coupled to the common terminal, which supplies the common potential. The output of the amplifier circuitry 720 is coupled to the initialization circuitry 220, the resistors 730, 740, the capacitor 735, and the output of the AC compensated sense circuitry 700.

The capacitor 725 has a first terminal and a second terminal. The first terminal of the capacitor 725 is coupled to the resistor 715 and the amplifier circuitry 720. The second terminal of the capacitor 725 is coupled to the resistor 730.

The resistor 730 has a first terminal and a second terminal. The first terminal of the resistor 730 is coupled to the capacitor 725. The second terminal of the resistor 730 is coupled to the initialization circuitry 220, the amplifier circuitry 720, the capacitor 735, and the resistor 740.

The capacitor 735 has a first terminal and a second terminal. The first terminal of the capacitor 735 is coupled to the initialization circuitry 220, the amplifier circuitry 720, and the resistors 730, 740. The second terminal of the capacitor 735 is coupled to the capacitors 230, 745 and the resistors 740, 750.

The resistor 740 has a first terminal and a second terminal. The first terminal of the resistor 740 is coupled to the initialization circuitry 220, the amplifier circuitry 720, the resistor 730, and the capacitor 735. The second terminal of the resistor 740 is coupled to the capacitors 230, 735, 745 and the resistor 750.

The capacitor 745 has a first terminal and a second terminal. The first terminal of the capacitor 745 is coupled to the capacitors 230, 735 and the resistors 740, 750. The second terminal of the capacitor 745 is coupled to the diode circuitry 240, the guard buffer circuitry 250, the amplifier circuitry 710, and the first input of the AC compensated sense circuitry 700, which supplies the measurement current.

The resistor 750 has a first terminal and a second terminal. The first terminal of the resistor 750 is coupled to the capacitors 230, 735, 745 and the resistor 740. The second terminal of the resistor 750 is coupled to the common terminal, which supplies the common potential.

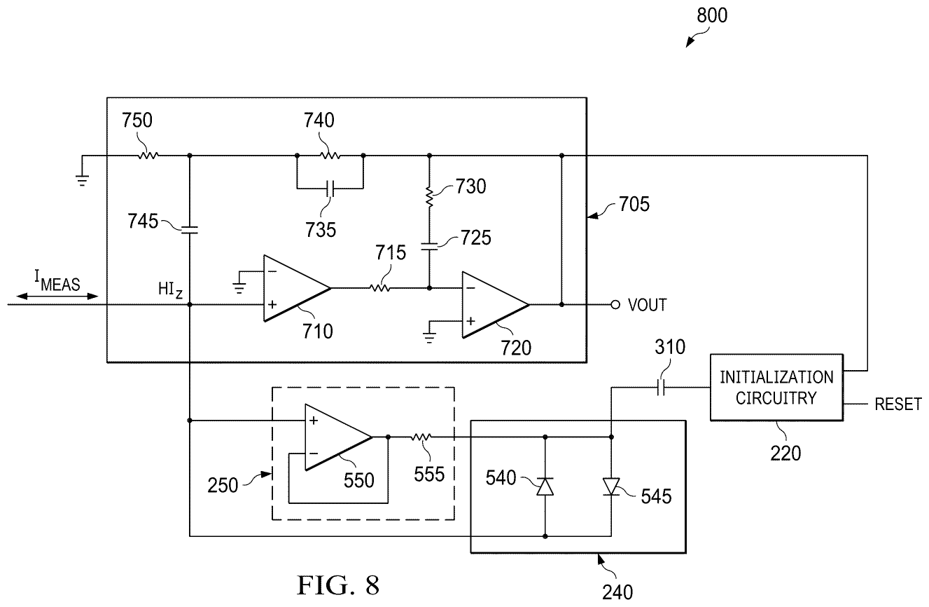

FIG. 8 is a schematic diagram of example AC compensated sense circuitry 800, which is an example of the AC compensated sense circuitry 120, 300. In the example of FIG. 8, the AC compensated sense circuitry 800 includes the initialization circuitry 220, the diode circuitry 240, the guard buffer circuitry 250, the capacitor 310, and the charge integrator circuitry 705. The example diode circuitry 240 of FIG. 8 includes the diodes 540, 545. The example guard buffer circuitry 250 of FIG. 8 includes the amplifier circuitry 550 and the resistor 555. The example charge integrator circuitry 705 of FIG. 8 includes the amplifier circuitry 710, the resistors 715, 730, 740, 750, the amplifier circuitry 720, and the capacitors 725, 735, 745.

The AC compensated sense circuitry 800 has a first input, a second input, and an output. The first input of the AC compensated sense circuitry 800 (also referred to as the high impedance input (HI_{Z})) is structured to be coupled to the sensor 110, which supplies or sinks a measurement current (I_{MEAS}). Unlike the examples of FIGS. 5 and 6, the high impedance input of the AC compensated sense circuitry 800 is a non-inverting input of the amplifier circuitry 710. The second input of the AC compensated sense circuitry 800 is structured to be coupled to the programmable circuitry 130, which supplies a reset indication (RESET). The output of the AC compensated sense circuitry 800 is structured to be coupled to the programmable circuitry 130.

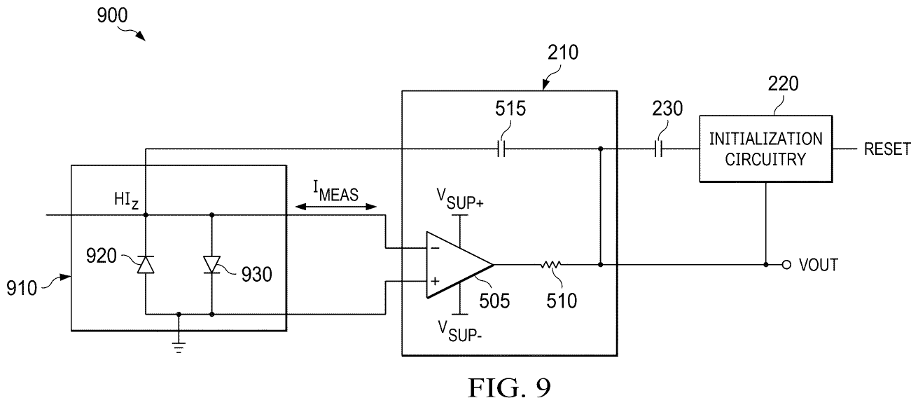

FIG. 9 is a schematic diagram of example AC compensated sense circuitry 900, which is an example of the AC compensated sense circuitry 120, 200, 300, 500, 600, 700, 800. In the example of FIG. 9, the AC compensated sense circuitry 900 includes the charge integrator circuitry 210, the initialization circuitry 220, the capacitor 230, and example diode circuitry 910. The example charge integrator circuitry 210 of FIG. 9 includes the amplifier circuitry 505, the resistor 510, and the capacitor 515. The example diode circuitry 910 of FIG. 9 includes a first example diode 920 and a second example diode 930.

The AC compensated sense circuitry 900 has a first input, a second input, and an output. The first input of the AC compensated sense circuitry 900 (also referred to as the high-impedance input (HI_{Z})) is structured to be coupled to the sensor 110, which supplies or sinks a measurement current (I_{MEAS}). The second input of the AC compensated sense circuitry 900 is structured to be coupled to the programmable circuitry 130, which supplies a reset indication (RESET). The output of the AC compensated sense circuitry 900 is structured to be coupled to the programmable circuitry 130, which receives an output voltage (VOUT).

The diode circuitry 910 has a first terminal and a second terminal. The first terminal of the diode circuitry 910 is coupled to the charge integrator circuitry 210 and the high impedance input of the AC compensated sense circuitry 900. The second terminal of the diode circuitry 910 is coupled to the charge integrator circuitry 210 and the common terminal, which supplies the common potential.

The diode 920 has a first terminal and a second terminal. The first terminal of the diode 920 is coupled to the charge integrator circuitry 210, the diode 930, and the high impedance input of the AC compensated sense circuitry 900. The second terminal of the diode 920 is coupled to the charge integrator circuitry 210, the diode 930, and the common terminal, which supplies the common potential.

The diode 930 has a first terminal and a second terminal. The first terminal of the diode 930 is coupled to the charge integrator circuitry 210, the diode 920, and the high impedance input of the AC compensated sense circuitry 900. The second terminal of the diode 930 is coupled to the charge integrator circuitry 210, the diode 920, and the common terminal, which supplies the common potential.

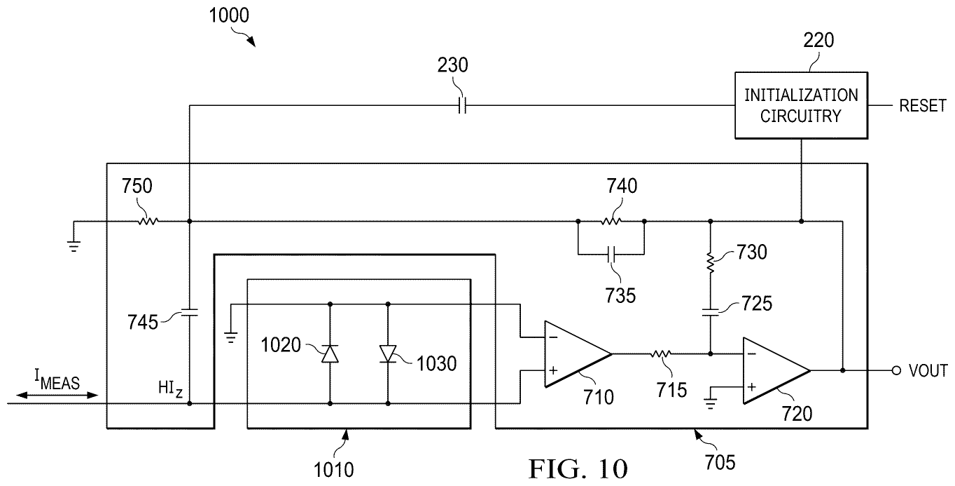

FIG. 10 is a schematic diagram of example AC compensated sense circuitry 800, which is an example of the AC compensated sense circuitry 120, 200, 300, 500, 600, 700, 800, 900. In the example of FIG. 10, the AC compensated sense circuitry 1000 includes the initialization circuitry 220, the capacitor 230, and the charge integrator circuitry 705. The example diode circuitry 240 of FIG. 10 includes the diodes 540, 545. The example charge integrator circuitry 705 of FIG. 10 includes the amplifier circuitry 710, the resistors 715, 730, 740, 750, the amplifier circuitry 720, and the capacitors 725, 735, 745. The example diode circuitry 1010 of FIG. 10 includes a first example diode 1020 and a second example diode 1030.

The AC compensated sense circuitry 1000 has a first input, a second input, and an output. The first input of the AC compensated sense circuitry 1000 (also referred to as the high impedance input (HI_{Z})) is structured to be coupled to the sensor 110, which supplies or sinks a measurement current (I_{MEAS}). Unlike the examples of FIGS. 5 and 6, the high impedance input of the AC compensated sense circuitry 1000 is a non-inverting input of the amplifier circuitry 710. The second input of the AC compensated sense circuitry 1000 is structured to be coupled to the programmable circuitry 130, which supplies a reset indication (RESET). The output of the AC compensated sense circuitry 1000 is structured to be coupled to the programmable circuitry 130.

The diode circuitry 1010 has a first terminal and a second terminal. The first terminal of the diode circuitry 1010 is coupled to the charge integrator circuitry 705 and the high impedance input of the AC compensated sense circuitry 1000. The second terminal of the diode circuitry 1010 is coupled to the charge integrator circuitry 705 and the common terminal, which supplies the common potential.

The diode 1020 has a first terminal and a second terminal. The first terminal of the diode 1020 is coupled to the charge integrator circuitry 705, the diode 1030, and the high impedance input of the AC compensated sense circuitry 1000. The second terminal of the diode 1020 is coupled to the charge integrator circuitry 705, the diode 1030, and the common terminal, which supplies the common potential.

The diode 1030 has a first terminal and a second terminal. The first terminal of the diode 1030 is coupled to the charge integrator circuitry 705, the diode 1020, and the high impedance input of the AC compensated sense circuitry 1000. The second terminal of the diode 1030 is coupled to the charge integrator circuitry 705, the diode 1020, and the common terminal, which supplies the common potential.

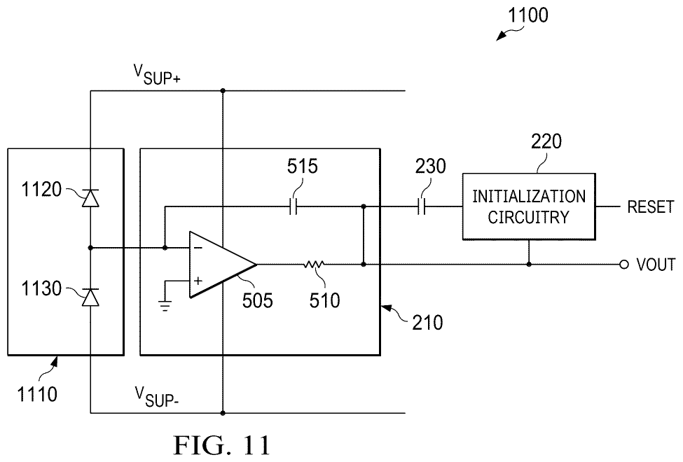

FIG. 11 is a schematic diagram of example AC compensated sense circuitry 1100, which is an example of the AC compensated sense circuitry 120, 200, 300, 500, 600, 700, 800, 900, 1000. In the example of FIG. 11, the AC compensated sense circuitry 1100 includes the charge integrator circuitry 210, the initialization circuitry 220, the capacitor 230, and example diode circuitry 1110. The example charge integrator circuitry 210 of FIG. 11 includes the amplifier circuitry 505, the resistor 510, and the capacitor 515. The example diode circuitry 1110 of FIG. 11 includes a first example diode 1120 and a second example diode 1130.

The AC compensated sense circuitry 1100 has a first input, a second input, and an output. The first input of the AC compensated sense circuitry 1100 (also referred to as the high-impedance input (HI_{Z})) is structured to be coupled to the sensor 110, which supplies or sinks a measurement current (I_{MEAS}). The second input of the AC compensated sense circuitry 1100 is structured to be coupled to the programmable circuitry 130, which supplies a reset indication (RESET). The output of the AC compensated sense circuitry 1100 is structured to be coupled to the programmable circuitry 130, which receives an output voltage (VOUT).

The diode circuitry 1110 has a first terminal, a second terminal, and a third terminal. The first terminal of the diode circuitry 1110 is coupled to the high-side supply terminal of the amplifier 505, which supplies the high-side supply voltage. The second terminal of the diode circuitry 1110 is coupled to the charge integrator circuitry 210 and the high-impedance input of the AC compensated sense circuitry 1100. The third terminal of the diode circuitry 1110 is coupled to the low-side supply terminal of the amplifier 505, which supplies the low-side supply voltage.

The diode 1120 has a first terminal and a second terminal. The first terminal of the diode 1120 is coupled to the high-side supply terminal of the amplifier 505, which supplies the high-side supply voltage. The second terminal of the diode 1120 is coupled to the charge integrator circuitry 210, the diode 1130, and the high-impedance input of the AC compensated sense circuitry 1100.

The diode 1130 has a first terminal and a second terminal. The first terminal of the diode 1130 is coupled to the charge integrator circuitry 210, the diode 1120, and the high impedance input of the AC compensated sense circuitry 1100. The second terminal of the diode 1130 is coupled to the low-side supply terminal of the amplifier 505, which supplies the low-side supply voltage.

FIG. 12 is a flowchart representative of example machine-readable instructions or example operations 1200 that may be at least one of executed, instantiated, or performed using an example implementation of the AC compensated sense circuitry 500, 600, 700, 800, 900, 1000, 1100. The example operations 1200 of FIG. 12 begin at Block 1210 at which the comparator circuitry 520, 530 determine if a reset indication has been received. In example operations, the programmable circuitry 130 generates the reset indication by setting the second input of the AC compensated sense circuitry 200, 500, 600, 700, 800, 900, 1000, 1100 to one of a first state or a second state. In the first state (e.g., a logic low, logical zero, etc.), the reset indication represents a determination by the programmable circuitry 130 that no reset is needed. In the second state (e.g., a logic high, logical one, etc.), the reset indication represents a determination by the programmable circuitry 130 that a reset is needed.

If the comparator circuitry 520, 530 determines that a reset indication has been received (e.g., Block 1210 returns a result of YES), the comparator circuitry 520 determines if an output voltage is greater than desired voltage, ground voltage for example. (Block 1220). In example operations, the comparator circuitry 520, 530 compares the output voltage of the AC compensated sense circuitry 200, 500, 600, 700, 800, 900, 1000, 1100 to the desired voltage responsive to receiving a reset indication. In such example operations, the comparator circuitry 520, 530 use the comparison to the desired voltage to determine whether positive or negative charge has accumulated at the high impedance input of the AC compensated sense circuitry 200, 500, 600, 700, 800, 900, 1000, 1100. For example, the comparator circuitry 520 detects an accumulation of positive charges at the high impedance input of the AC compensated sense circuitry 200, 500, 600, 700, 800, 900, 1000, 1100 responsive to the output voltage being greater than the desired voltage. In another example, the comparator circuitry 520 detects an accumulation of negative charge at the high impedance input of the AC compensated sense circuitry 200, 500, 600, 700, 800, 900, 1000, 1100 responsive to the output voltage being less than the desired voltage.

If the comparator circuitry 520, 530 determines that a reset indication has not been received (e.g., Block 1210 returns a result of NO), the comparator circuitry 520 determines if the output voltage is approaching a first reference voltage. (Block 1230). In example operations, the comparator circuitry 520 compares the output voltage at the output of the AC compensated sense circuitry 200, 500, 600, 700, 800, 900, 1000, 1100 to the high-side supply voltage of the amplifier circuitry 505. The high-side supply voltage represents the maximum voltage that the amplifier circuitry 505 may produce. In some examples, the output of the amplifier circuitry 505 is saturated at voltages near the high-side supply voltage. In such example operations, the high-side supply voltage also represents the maximum output voltage of the AC compensated sense circuitry 200, 500, 600, 700, 800, 900, 1000, 1100. Advantageously, the comparator circuitry 520 detects a positive charge accumulation saturating the output voltage of the amplifier circuitry 505, 710 based on the comparison of the output voltage to the high-side supply voltage.

If the comparator circuitry 520 determines the output voltage is greater than desired voltage (e.g., Block 1220 returns a result of YES) or the comparator circuitry 520 determines the output voltage is approaching the first reference voltage (e.g., Block 1230 returns a result of YES), the AC source circuitry 525 generates a first AC signal to decrease the output voltage. (Block 1240). In example operations, the AC source circuitry 525 generates a first AC signal responsive to the comparator circuitry 520 detecting a positive charge accumulation at the first input of the AC compensated sense circuitry 200, 500, 600, 700, 800, 900, 1000, 1100. In some examples, the capacitor 230 supplies the first AC signal to the capacitor 515, which couples AC signals to the high impedance input of the amplifier circuitry 405. In another example, the capacitor 230 supplies the first AC signal to the capacitor 745, which couples AC signals to the high impedance input of the amplifier circuitry 710. In yet another example, the capacitor 310 supplies the first AC signal to the diodes 540, 545, which couple AC signals to the high impedance input of the amplifier circuitry 405. In such example operations, the first AC signal decreases the positive charge accumulation by driving excess charges through the diodes 540, 545. Examples structures of AC signals to decrease positive charge accumulation are further illustrated and described in connection with FIGS. 13A, 15A, and 16A, below.

If the comparator circuitry 520 determines the output voltage is not approaching the first reference voltage (e.g., Block 1230 returns a result of NO), the comparator circuitry 530 determines if the output voltage is approaching a second reference voltage. (Block 1250). In example operations, the comparator circuitry 530 compares the output voltage at the output of the AC compensated sense circuitry 200, 500, 600, 700, 800, 900, 1000, 1100 to the low-side supply voltage of the amplifier circuitry 505. The low-side supply voltage represents the minimum voltage that the amplifier circuitry 505 may produce. In some examples, the output of the amplifier circuitry 505 is saturated at voltages near the low-side supply voltage. In such example operations, the low-side supply voltage also represents the minimum output voltage of the AC compensated sense circuitry 200, 500, 600, 700, 800, 900, 1000, 1100. Advantageously, the comparator circuitry 530 detects a negative charge accumulation saturating the output voltage of the amplifier circuitry 505, 710 based on the comparison of the output voltage to the low-side supply voltage. If the comparator circuitry 530 determines the output voltage is not approaching the second reference voltage (e.g., Block 1250 returns a result of NO), control proceeds to perform the operations of Block 450.

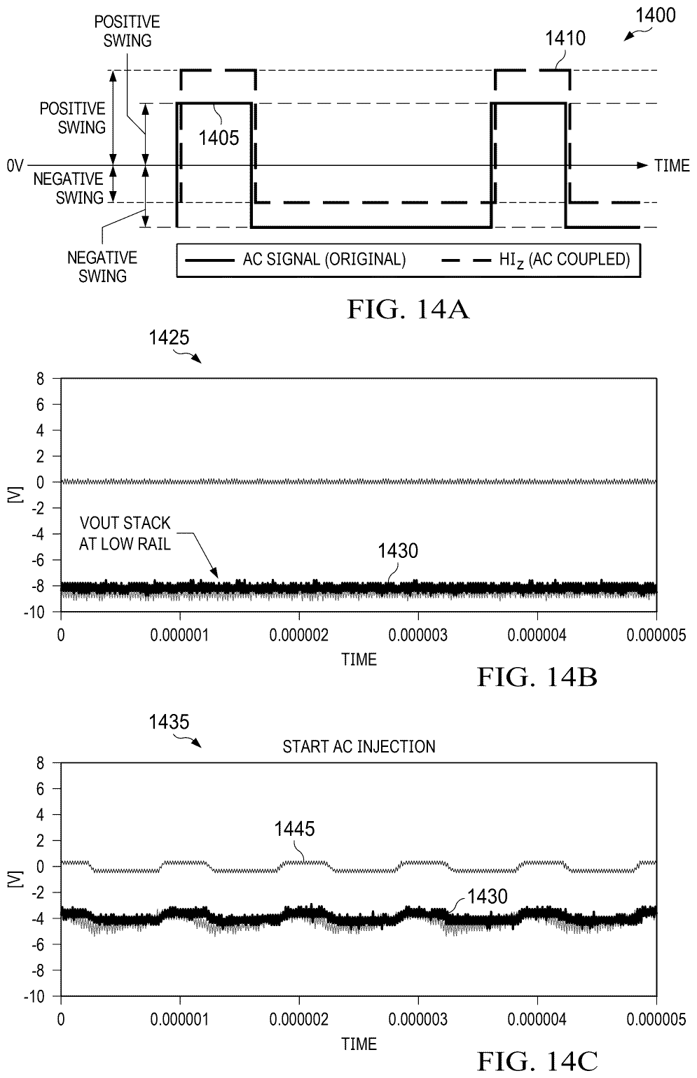

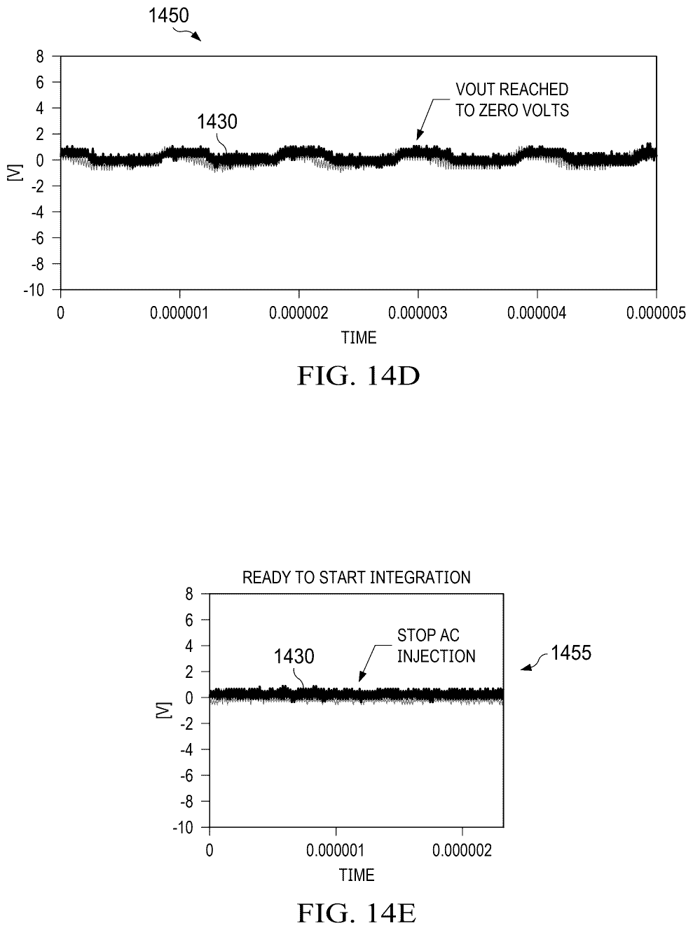

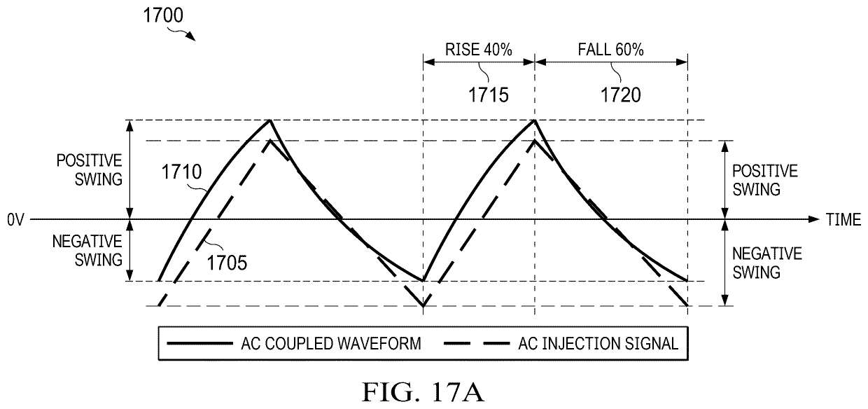

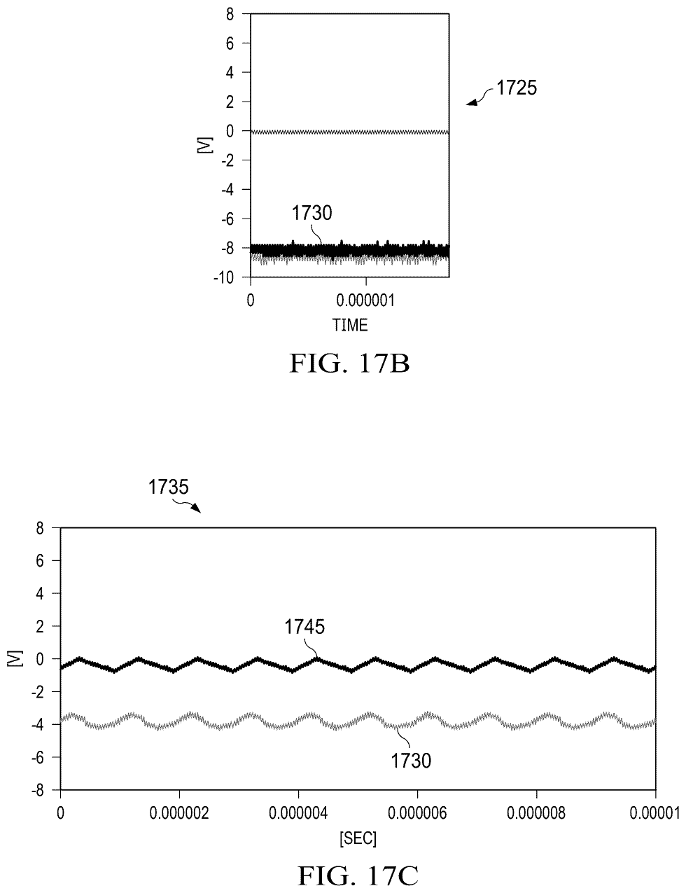

If the comparator circuitry 530 determines the output voltage is not greater than the desired voltage (e.g., Block 1220 returns a result of NO) or the comparator circuitry 530 determines the output voltage is approaching the second reference voltage (e.g., Block 1250 returns a result of YES), the AC source circuitry 535 generates a second AC signal to increase the output voltage. (Block 1260). In example operations, the AC source circuitry 425 generates a second AC signal responsive to the comparator circuitry 530 detecting a negative charge accumulation at the high impedance input of the AC compensated sense circuitry 200, 500, 600, 700, 800, 900, 1000, 1100. In some examples, the capacitor 230 supplies the second AC signal to the capacitor 515, which couples AC signals to the high impedance input of the amplifier circuitry 505. In another example, the capacitor 230 supplies the second AC signal to the capacitor 745, which couples AC signals to the high impedance input of the amplifier circuitry 710. In yet another example, the capacitor 310 supplies the second AC signal to the diodes 540, 545, 920, 930, 1020, 1030, 1120, 1130, which couple AC signals to the high impedance input of the amplifier circuitry 405. In such example operations, the AC signal is structured to decrease the negative charge accumulation by driving excess charges to the first input of the AC compensated sense circuitry 200, 500, 600, 700, 800, 900, 1000, 1100 from the diodes 540, 545, 920, 930, 1020, 1030, 1120, 1130. Examples structures of AC signals to decrease negative charge accumulation are further illustrated and described in connection with FIGS. 14A and 17A, below. Control proceeds to perform the operations of Blocks 430, 440, 450, 460, 470.

Example methods are described with reference to the flowchart illustrated in FIG. 12. However, many other methods of implementing the AC compensated sense circuitry 500, 600, 700, 800, 900, 1000, 1100 may also be used in this description, such as in FIG. 4. For example, the order of execution of the blocks may be changed, or some of the blocks described may be changed, eliminated, or combined. Similarly, additional operations may be included in the manufacturing process before, in between, or after the blocks shown in the illustrated examples.

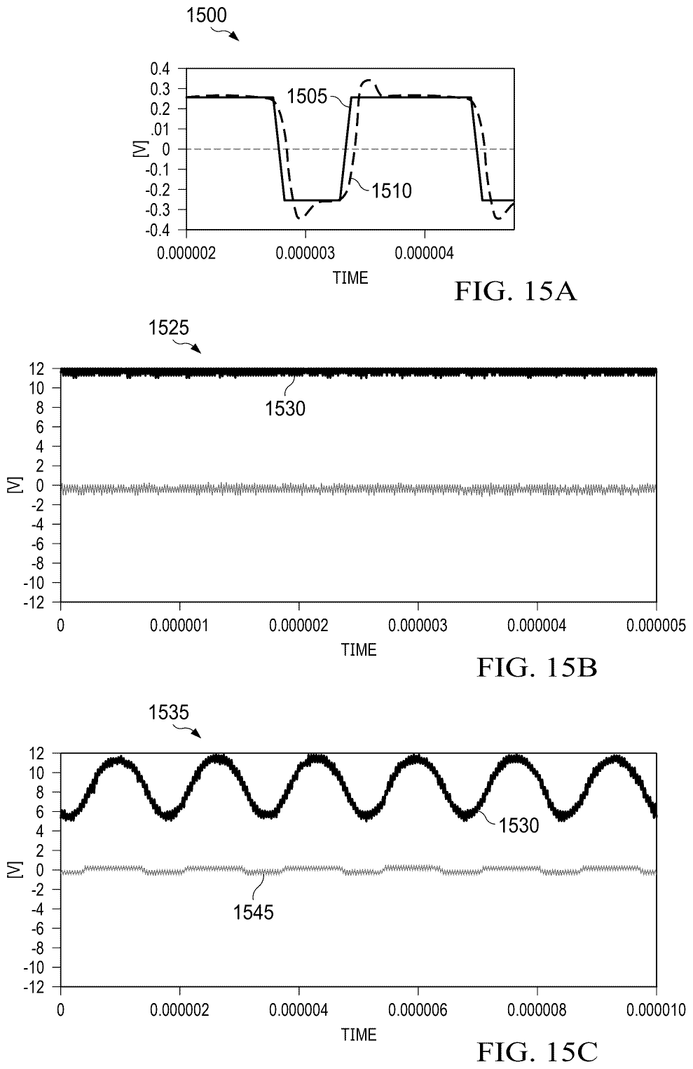

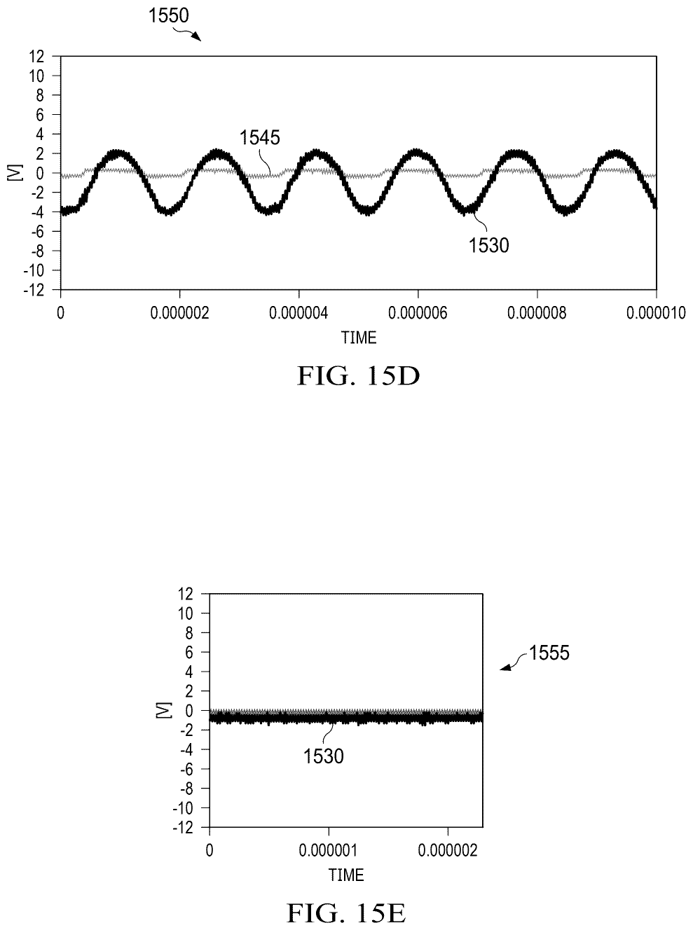

FIGS. 13A, 13B, 13C, 13D, and 13E are timing diagrams of example operations of the initialization circuitry 220 or more generally the AC compensated sense circuitry 200, 500, 900 using a square waveform. FIG. 13A is a timing diagram 1300 of an example AC signal 1305 and an example high impedance coupled AC signal 1310. The AC signal 1305 represents the output of the AC source circuitry 535. In the examples of FIGS. 13A, 13B, 13C, 13D, and 13E, the AC signal 1305 is a square waveform. In other examples, such as FIGS. 15A, 16A, and 17A, the AC signal 1305 is an alternative waveform. The high impedance coupled AC signal 1310 represents the portions of the AC signal 1305 at the high impedance input of the AC compensated sense circuitry 200, 500, 900. For example, the high impedance coupled AC signal 1310 illustrates the AC signal 1305 after traversing at least the capacitors 230, 515 to the first input of the AC compensated sense circuitry 200, 500, 900.

In the example operations of FIGS. 13A, 13B, 13C, 13D, and 13E, the high impedance coupled AC signal 1310 has a negative voltage swing (below the ground voltage) that is greater than a positive voltage swing (above the ground voltage). During example injection of the AC signal 1305, accumulated charges at the first input of the AC compensated sense circuitry 200, 500, 900 flow through the diode circuitry 240, 910 to ground responsive to the negative voltage swing of the high impedance coupled AC signal 1310. For example, the negative voltage swing of the high impedance coupled AC signal 1310 exceeds the threshold of the diodes 545, 920 and the positive voltage swing of the high impedance coupled AC signal 1310 is less than the threshold of the diodes 540, 930. In such examples, the high impedance coupled AC signal 1310 reduces positive charge accumulation responsive to the diodes 545, 920 conducting a current exponentially greater than the diodes 540, 930.

FIG. 13B is a timing diagram 1325 of an example output voltage 1330. The output voltage 1330 represents a voltage at the output of the AC compensated sense circuitry 200, 500. The AC injection signal 1345 represents an output signal of the initialization circuitry 220 over time. The timing diagram 1325 illustrates the output voltage 1330 during pre-injection operations, which occur before injecting the AC signal 1305. Prior to the example operations of the timing diagram 1325, an accumulation of charges at the high impedance input of the AC compensated sense circuitry 200, 500 occurs responsive to the measurement current sinking current from a high impedance terminal of the charge integrator circuitry 210. In such example operations, the capacitor 515 sets the output voltage 1330 to the high-side supply voltage (SUP+) of the amplifier circuitry 505.

FIG. 13C is a timing diagram 1335 of the output voltage 1330 and an example AC injection signal 1345 during an example injection of the AC signal 1305. The AC injection signal 1445 represents the output of the initialization circuitry 220 over time. In the example operations of the timing diagram 1335, which follow the operations of the timing diagram 1325, the negative voltage swing of the high impedance coupled AC signal 1310 drives charges, which set the output voltage 1330, through the diode circuitry 240 to the AC injection signal 1345. Advantageously, during the charge injection illustrated in the timing diagram 1335, supplying the AC signal 1305 to the capacitor 230 decreases the output voltage 1330 by causing an accumulation of charges at the high impedance input of the AC compensated sense circuitry 200, 500.

FIG. 13D is a timing diagram 1350 of the output voltage 1330 and the AC injection signal 1345 nearing the end of the injection of the AC signal 1305. In the example operations of the timing diagram 1350, which follow the operations of the timing diagram 1325, the negative voltage swing of the high impedance coupled AC signal 1310 continues to decrease the output voltage 1330. However, during the operations of the timing diagram 1350, the output voltage 1330 is approximately equal to a reference voltage (also referred to as a target voltage). Advantageously, at the time represented by the timing diagram 1350, the initialization circuitry 220 has greatly reduced the accumulated charge from the first input of the AC compensated sense circuitry 200, 500.

FIG. 13E is a timing diagram 1355 of the output voltage 1330 and the AC injection signal 1345 after the injection of the AC signal 1305. In the example operations of the timing diagram 1355, the initialization circuitry 220 no longer injects the AC signal 1305. In some examples, the initialization circuitry 220 may continue to inject the AC signal 1305 for a duration of time after being equal to the AC injection signal 1345.In some examples, the AC signal 1305 allows the AC compensated sense circuitry 200, 500 to start integration operations at a non-zero output voltage. In such examples, the non-zero output voltage allows the AC Compensated sense circuitry 200, 500 to account for dielectric relaxation responsive to having a zero crossing when supplying the AC signal 1305. For example, the dielectric relaxation begins to compound as the output voltage 1330 increases responsive to the derivative of the output voltage 1330 compounding as a leakage current. However, the leakage current across the capacitor 515 is substantially smaller when the output voltage 1330 is near zero. Advantageously, the zero crossing during AC integration ensures that the voltage difference across the integrating capacitor crosses zero volts. Advantageously, setting the voltage across the integrating capacitor to zero reduces the leakage current, which reduces measurement errors resulting from dielectric relaxation. Advantageously, the AC compensated sense circuitry 200, 500 may begin to accurately sense the measurement current at the first input after the operations of timing diagrams 1325, 1335, 1350. Advantageously, the AC compensated sense circuitry 200, 500 has a higher accuracy responsive to the AC injection of the AC signal 1305 removing charges across the capacitor 515.

FIGS. 14A, 14B, 14C, 14D, and 14E are timing diagrams of example operations of the initialization circuitry 220 or more generally the AC compensated sense circuitry 200, 500, 900 using a square waveform. FIG. 14A is a timing diagram 1400 of an example AC signal 1405 and an example high impedance coupled AC signal 1410. The AC signal 1405 represents the output of the AC source circuitry 425. In the examples of FIGS. 14A, 14B, 14C, 14D, and 14E, the AC signal 1405 is a square waveform. In other examples, such as FIGS. 15A, 16A, and 17A, the AC signal 1405 may be an alternative waveform. The high impedance coupled AC signal 1410 represents the portions of the AC signal 1405 at the high impedance input of the AC compensated sense circuitry 200, 500, 900. For example, the high impedance coupled AC signal 1410 illustrates the AC signal 1405 after traversing at least the capacitors 230, 515 to the high impedance input of the AC compensated sense circuitry 200, 500, 900.

In the example operations of FIGS. 14A, 14B, 14C, 14D, and 14E, the high impedance coupled AC signal 1410 has a positive voltage swing (above the ground voltage) that is greater than a negative voltage swing (below the ground voltage). During example injection of the AC signal 1405, the diode circuitry 240, 910 supplies charge from a buffered ground to the first input of the AC compensated sense circuitry 200, 500, 900 responsive to the positive voltage swing of the high impedance coupled AC signal 1410. Advantageously, injecting AC signals with positive voltage swings that are greater than negative voltage swings accounts for an accumulation of negative charges at the first input of the AC compensated sense circuitry 200, 500, 900.

For example, the positive voltage swing of the high impedance coupled AC signal 1410 exceeds the threshold of the diodes 540, 930 and the negative voltage swing of the high impedance coupled AC signal 1410 is less than the threshold of the diodes 545, 920. In such examples, the high impedance coupled AC signal 1410 reduces negative charge accumulation responsive to the diodes 540, 930 conducting a current exponentially greater than the diodes 545, 920.

FIG. 14B is a timing diagram 1425 of an example output voltage 1430 and an example reference voltage (also referred to as a target voltage). The output voltage 1430 represents a voltage at the output of the AC compensated sense circuitry 200, 500, 900. The reference voltage represents a target value of the output voltage 1430. The timing diagram 1425 illustrates the output voltage 1430 during pre-injection operations that occur before injecting the AC signal 1405. Prior to the example operations of the timing diagram 1425, an accumulation of positive charges at the high impedance input of the AC compensated sense circuitry 200, 500, 900 occurs responsive to the measurement current supplying current to a high impedance terminal of the charge integrator circuitry 210. In such example operations, the capacitor 515 sets the output voltage 1430 to the low-side supply voltage (SUP-) of the amplifier circuitry 505.

FIG. 14C is a timing diagram 1435 of the output voltage 1430 and an example AC injection signal 1445 during an example injection of the AC signal 1405. The AC injection signal 1445 represents the output of the initialization circuitry 220 over time. In the example operations of the timing diagram 1435, which follow the operations of the timing diagram 1425, the positive voltage swing of the high impedance coupled AC signal 1410 drives charges, which set the output voltage 1430, from the AC injection signal 1445 through the diode circuitry 240, 910 to the first input of the AC compensated sense circuitry 200, 500, 900. Advantageously, during the charge injection illustrated in the timing diagram 1435, supplying the AC signal 1405 to the capacitor 230 increases the output voltage 1430 by causing negative charges from the guard buffer circuitry 250 to compensate for accumulated negative charge at the first input of the AC compensated sense circuitry 200, 500, 900.

FIG. 14D is a timing diagram 1450 of the output voltage 1430 and the AC injection signal 1445 nearing the end of the injection of the AC signal 1405. In the example operations of the timing diagram 1450, which follow the operations of the timing diagram 1435, the positive voltage swing of the high impedance coupled AC signal 1410 continues to increase the output voltage 1430. However, during the operations of the timing diagram 1450, the output voltage 1430 is approximately equal to a reference voltage (also referred to as a target voltage). Advantageously, at the time represented by the timing diagram 1450, the initialization circuitry 220 has greatly reduced the accumulated positive charge at the high impedance input of the AC compensated sense circuitry 200, 500, 900.

FIG. 14E is a timing diagram 1455 of the output voltage 1430 and the AC injection signal 1445 after the injection of the AC signal 1405. In the example operations of the timing diagram 1455, the initialization circuitry 220 no longer injects the AC signal 1405. In some examples, the initialization circuitry 220 may continue to inject the AC signal 1405 for a duration of time after being equal to the AC injection signal 1445. In some examples, the AC signal 1405 allows the AC compensated sense circuitry 200, 500 to start integration operations at a non-zero output voltage. In such examples, the non-zero output voltage allows the AC Compensated sense circuitry 200, 500 to account for dielectric relaxation responsive to having a zero crossing when supplying the AC signal 1405. For example, the dielectric relaxation begins to compound as the output voltage 1330 increases responsive to the derivative of the output voltage 1430 compounding as a leakage current. However, the leakage current across the capacitor 515 is substantially smaller when the output voltage 1430 is near zero. Advantageously, the zero crossing during AC integration ensures that the voltage difference across the integrating capacitor crosses zero volts. Advantageously, setting the voltage across the integrating capacitor to zero reduces the leakage current, which reduces measurement errors resulting from dielectric relaxation. Advantageously, the AC compensated sense circuitry 200, 500, 900 may begin to accurately sense the measurement current at the first input after the operations of timing diagrams 1425, 1435, 1450. Advantageously, the AC compensated sense circuitry 200, 500, 900 has a higher accuracy responsive to the AC injection of the AC signal 1405 removing charges across the capacitor 515.

In the example of FIGS. 13A, 13B, 13C, 13D, 13E, 14A, 14B, 14C, 14D, and 14E, the timing diagrams are described in reference to injecting the AC signals 1305, 1405 into the AC compensated sense circuitry 200, 500, 900. In these examples, the initialization circuitry 220 and the capacitor 230 are structured to supply the AC signals 1305, 1405 at the output of the AC compensated sense circuitry 200, 500, 900. In such examples, positive voltage swings of AC signals correspond to the conduction of current through the diodes 540, 930 and negative voltage swings of AC signals correspond to the conduction of current through the diodes 545, 920.

However, in the example of FIGS. 3, 6, and 8, the initialization circuitry 220 and the capacitor 310 are structured to supply the AC signals 1305, 1405 at the buffered ground between diode circuitry 240 and the guard buffer circuitry 250. In such examples, negative voltage swings of AC signals correspond to the conduction of current through the diodes 540, 920 and positive voltage swings of AC signals correspond to the conduction of current through the diodes 545, 930. Accordingly, AC signals having a positive voltage swing that is greater than the negative voltage swing drives current from the first input of the AC compensated sense circuitry 300, 600, 800 to ground through the diode circuitry 240. Similarly, AC signals having a negative voltage swing that is less than the positive voltage swing drives current from the diode circuitry 240 to the first input of the AC compensated sense circuitry 300, 600, 800. For example, in the case of the AC compensated sense circuitry 300, 600, 800, the example operations illustrated by the output voltage 1330 are in response to injecting the AC signal 1405 through the capacitor 310. Also, in the case of the AC compensated sense circuitry 300, 600, 800, the example operations illustrated by the output voltage 1430 are in response to injecting the AC signal 1305 through the capacitor 310.

FIGS. 15A, 15B, 15C, 15D, and 15E are timing diagrams of example operations of the initialization circuitry 220 or more generally the AC compensated sense circuitry 700 using a PWM waveform. FIG. 15A is a timing diagram 1500 of an example AC reference voltage 1505 and an example buffered AC reference voltage 1510. The AC reference voltage 1505 represents the input of the guard buffer circuitry 250 during AC injection. In the examples of FIGS. 15A, 15B, 15C, 15D, and 15E, the AC reference voltage 1505 is a PWM waveform having a duty cycle. In such examples, the duty cycle of the AC reference voltage 1505 is sixty-six percent. The buffered AC reference voltage 1510 represents the output of the guard buffer circuitry 250 responsive to the AC reference voltage 1505, which represents the voltage across the diode circuitry 240. In example operation, the difference between the buffered AC reference voltage 1510 and the AC reference voltage 1505 decides the direction of the current through the diode circuitry 240. The guard buffer circuitry 250 delays the setting of the buffered AC reference voltage 1510 in response to changes in the AC reference voltage 1505.

In the example operations of FIGS. 15A, 15B, 15C, 15D, and 15E, the AC reference voltage 1505 and the buffered AC reference voltage 1510 are structured to have a negative net current across each duty cycle. The net current is a summation of the total current supplied to and sunk across a duty cycle. For example, the voltage difference between AC reference voltage 1505 and the buffered AC reference voltage 1510 is applied across the diodes 540, 545, which sets the direction of the flow of current to produce a negative net current. Advantageously, injecting AC signals with negative net current from the diode circuitry 240 accounts for an accumulation of charges at the first input of the AC compensated sense circuitry 700.

The AC reference voltage 1505 illustrates the use of both the exponential increases and duration of current conduction to set the net current. For example, adjusting the duty cycle of the AC reference voltage 1505 adjusts the delta between the AC reference voltage 1505 and the buffered AC reference voltage 1510. Any net current occurring during clock cycles of the AC reference voltage 1505 and across the diodes 540, 545 adjusts the accumulation of charge at the high impedance input of the AC compensated sense circuitry 700.

FIG. 15B is a timing diagram 1525 of an example output voltage 1530 and an example reference voltage. The output voltage 1530 represents a voltage at the output of the AC compensated sense circuitry 700. The reference voltage represents a target voltage of the output voltage 1530 after AC injection operations. The timing diagram 1525 illustrates the output voltage 1530 during pre-injection operations that occur before injecting the AC reference voltage 1505. Prior to the example operations of the timing diagram 1525, an accumulation of negative charges at the high impedance input of the AC compensated sense circuitry 700 occurs responsive to the measurement current supplying current to a high impedance terminal of the charge integrator circuitry 705. In such example operations, the capacitor 745 sets the output voltage 1530 to the high-side supply voltage (SUP+) of the amplifier circuitry 720.

FIG. 15C is a timing diagram 1535 of the output voltage 1530 and an example AC injection signal 1545 during an example injection of the AC reference voltage 1505. The AC injection signal 1545 represents the output of the initialization circuitry 220 over time. In the example operations of the timing diagram 1535, which follow the operations of the timing diagram 1525, the net positive current by the guard buffer circuitry 250 drives charges, which set the output voltage 1530, from the first input of the AC compensated sense circuitry 700 through the diode circuitry 240. Advantageously, during the charge injection illustrated in the timing diagram 1535, supplying the AC reference voltage 1505 to the capacitor 230 decreases the output voltage 1530 by using accumulated charges at the first input of the AC compensated sense circuitry 700 to compensate for a negative net current of the AC reference voltage 1505.

FIG. 15D is a timing diagram 1550 of the output voltage 1530 and the AC injection signal 1545 nearing the end of the injection of the AC reference voltage 1505. In the example operations of the timing diagram 1550, which follow the operations of the timing diagram 1535, the positive net current to the high impedance input of the AC compensated sense circuitry 700 continues to decrease the output voltage 1530. However, during the operations of the timing diagram 1550, the output voltage 1530 has an average voltage approximately equal to the reference voltage, which is approximately zero volts. Advantageously, at the time represented by the timing diagram 1550, the initialization circuitry 220 has greatly reduced the negative charge at the first input of the AC compensated sense circuitry 700.

FIG. 15E is a timing diagram 1555 of the output voltage 1530 and the AC injection signal 1545 after the injection of the AC reference voltage 1505. In the example operations of the timing diagram 1555, the initialization circuitry 220 no longer injects the AC reference voltage 1505. In some examples, the initialization circuitry 220 may continue to inject the AC reference voltage 1505 for a duration of time after being equal to the reference voltage, which is approximately zero volts. In some examples, the AC reference voltage 1505 allows the AC compensated sense circuitry 700 to start integration operations at a non-zero output voltage. In such examples, the non-zero output voltage allows the AC Compensated sense circuitry 700 to account for dielectric relaxation responsive to having a zero crossing when supplying the AC reference voltage 1505. For example, the dielectric relaxation begins to compound as the output voltage 1530 increases responsive to the derivative of the output voltage 1530 compounding as a leakage current. However, the leakage current across the capacitor 745 is substantially smaller when the output voltage 1530 is near zero. Advantageously, the zero crossing during AC integration ensures that the voltage difference across the integrating capacitor crosses zero volts. Advantageously, setting the voltage across the integrating capacitor to zero reduces the leakage current, which reduces measurement errors resulting from dielectric relaxation. Advantageously, the AC compensated sense circuitry 700 may begin to accurately sense the measurement current at the first input after the operations of timing diagrams 1525, 1535, 1550. Advantageously, the AC compensated sense circuitry 700 has a higher accuracy responsive to the AC injection of the AC reference voltage 1505 removing charges across the capacitor 745.

In the examples of FIGS. 15A, 15B, 15C, 15D, and 15E, the AC reference voltage 1505 and 1510 has a duty cycle that sets the net current to a positive value. In such examples, injecting the AC reference voltage 1505 and 1510 corresponds to decreasing the output voltage 1530. Alternatively, the AC reference voltage 1505 and 1510 may be modified to have a net current to the high impedance input that is negative value. In such examples, injecting the negative net current AC signal corresponds to increasing the output voltage 1530. Such an AC signal may be achieved by modifying the duty cycle of the AC reference voltage 1505 and 1510.

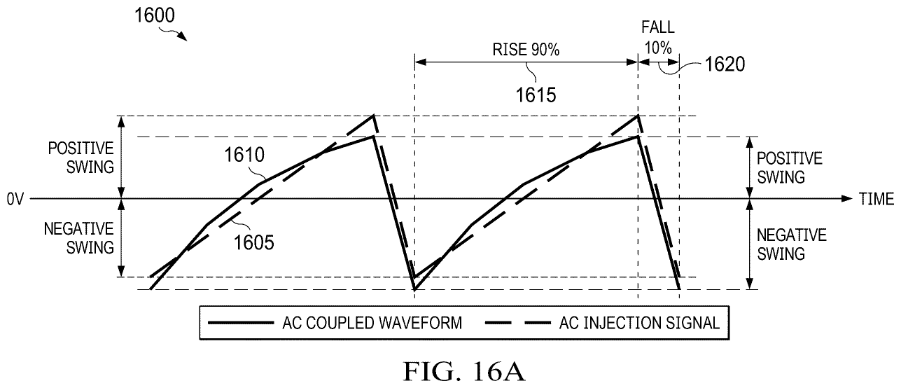

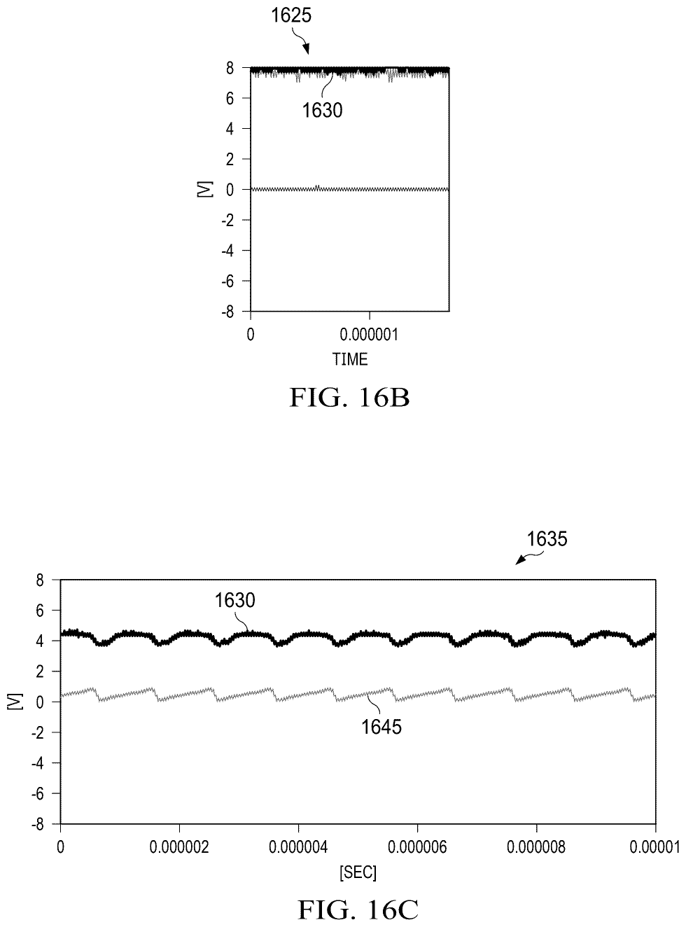

FIGS. 16A, 16B, and 16C are timing diagrams of example operations of the initialization circuitry 220 or more generally the AC compensated sense circuitry 200, 500, 700, 900 using a triangular waveform. FIG. 16A is a timing diagram 1600 of an example AC signal 1605 and an example high impedance coupled AC signal 1610. The AC signal 1605 represents the output of the AC source circuitry 535. In the examples of FIGS. 16A, 16B, and 16C, the AC signal 1605 is a triangular waveform having a duty cycle that is characterized by a rise time 1615 and a fall time 1620. During the rise time 1615, the AC signal 1605 has a linearly increasing voltage. During the fall time 1620, the AC signal 1605 has a linearly decreasing voltage. The high impedance coupled AC signal 1610 represents the portions of the AC signal 1605 at the first input of the AC compensated sense circuitry 200, 500, 700, 900. For example, the high impedance coupled AC signal 1610 illustrates the AC signal 1605 after traversing at least the capacitor 230 to the first input of the AC compensated sense circuitry 200, 500, 700, 900. In such examples, the capacitor 230 filters the relatively low frequency components of the AC signal 1605. In the example of FIG. 16A, the high impedance coupled AC signal 1610 has a negative voltage swing that is greater than the positive voltage swing. Advantageously, the high impedance coupled AC signal 1610 is centered on a common potential. In some examples, decreasing the fall time of the AC signal 1605 increases the negative voltage swing.

FIG. 16B is a timing diagram 1625 of an example output voltage 1630 and an example reference voltage (also referred to as a target voltage). The output voltage 1630 represents a voltage at the output of the AC compensated sense circuitry 200, 500, 700, 900. The timing diagram 1625 illustrates the output voltage 1630 during pre-injection operations that occur before injecting the AC signal 1605. Prior to the example operations of the timing diagram 1625, an accumulation of negative charges at the first input of the AC compensated sense circuitry 200, 500, 700, 900 occurs responsive to the measurement current supplying current to a high impedance terminal of the charge integrator circuitry 210. In such example operations, the capacitor 515 sets the output voltage 1630 to the high-side supply voltage (SUP+) of the amplifier circuitry 505.

FIG. 16C is a timing diagram 1635 of the output voltage 1630 and an example AC injection signal 1645 during an example injection of the AC signal 1605. The AC injection signal 1645 represents the output of the initialization circuitry 220 over time. In the example operations of the timing diagram 1635, which follow the operations of the timing diagram 1625, the negative voltage swing of the high impedance coupled AC signal 1610 drives charges, which set the output voltage 1630, through the diode circuitry 240 to the reference voltage. Advantageously, during the charge injection illustrated in the timing diagram 1635, supplying the AC signal 1605 to the capacitor 230 decreases the output voltage 1630 by causing accumulated charges to flow to a ground of the guard buffer circuitry 250.

FIGS. 17A, 17B, and 17C are timing diagrams of example operations of the initialization circuitry 220 or more generally the AC compensated sense circuitry 200, 500, 700, 900 using a triangular waveform. FIG. 17A is a timing diagram 1700 of an example AC signal 1705 and an example high impedance coupled AC signal 1710. The AC signal 1705 represents the output of the AC source circuitry 535. In the examples of FIGS. 17A, 17B, and 17C, the AC signal 1705 is a triangular waveform having a duty cycle that is characterized by a rise time 1715 and a fall time 1720. During the rise time 1715, the AC signal 1705 has a linearly increasing voltage. During the fall time 1720, the AC signal 1705 has a linearly decreasing voltage. The high impedance coupled AC signal 1710 represents the portions of the AC signal 1205 at the first input of the AC compensated sense circuitry 200, 500, 700, 900. For example, the high impedance coupled AC signal 1710 illustrates the AC signal 1705 after traversing at least the capacitor 230 to the first input of the AC compensated sense circuitry 200, 500, 700, 900. In such examples, the capacitor 230 filters the relatively low frequency components of the AC signal 1705. In the example of FIG. 17A, the high impedance coupled AC signal 1710 has a positive voltage swing that is greater than the negative voltage swing. Advantageously, the high impedance coupled AC signal 1710 is centered on a common potential. In some examples, decreasing the rise time increases the positive voltage swing.

FIG. 17B is a timing diagram 1725 of an example output voltage 1730 and an example reference voltage (also referred to as a target voltage). The output voltage 1730 represents a voltage at the output of the AC compensated sense circuitry 200, 500, 700, 900. The reference voltage represents a target value of the output voltage 1730. The timing diagram 1725 illustrates the output voltage 1730 and the reference voltage during pre-injection operations that occur before injecting the AC signal 1705. Prior to the example operations of the timing diagram 1725, an accumulation of positive charges at the first input of the AC compensated sense circuitry 200, 500, 700, 900 occurs responsive to the measurement current supplying current to a high impedance terminal of the charge integrator circuitry 210. In such example operations, the capacitor 515 sets the output voltage 1730 to the low-side supply voltage (SUP−) of the amplifier circuitry 505.

FIG. 17C is a timing diagram 1735 of the output voltage 1730 and an example AC injection signal 1745 during an example injection of the AC signal 1705. The AC injection signal 1745 represents the output of the initialization circuitry 220 over time. In the example operations of the timing diagram 1735, which follow the operations of the timing diagram 1725, the positive voltage swing of the high impedance coupled AC signal 1710 drives charges, which set the output voltage 1730, from AC injection signal 1745 through the diode circuitry 240 to the first input of the AC compensated sense circuitry 200, 500, 700, 900. Advantageously, during the charge injection illustrated in the timing diagram 1735, supplying the AC signal 1705 to the capacitor 230 increases the output voltage 1730 by accumulating charges from the diode circuitry 240 at the first input of the AC compensated sense circuitry 200, 500, 700, 900.

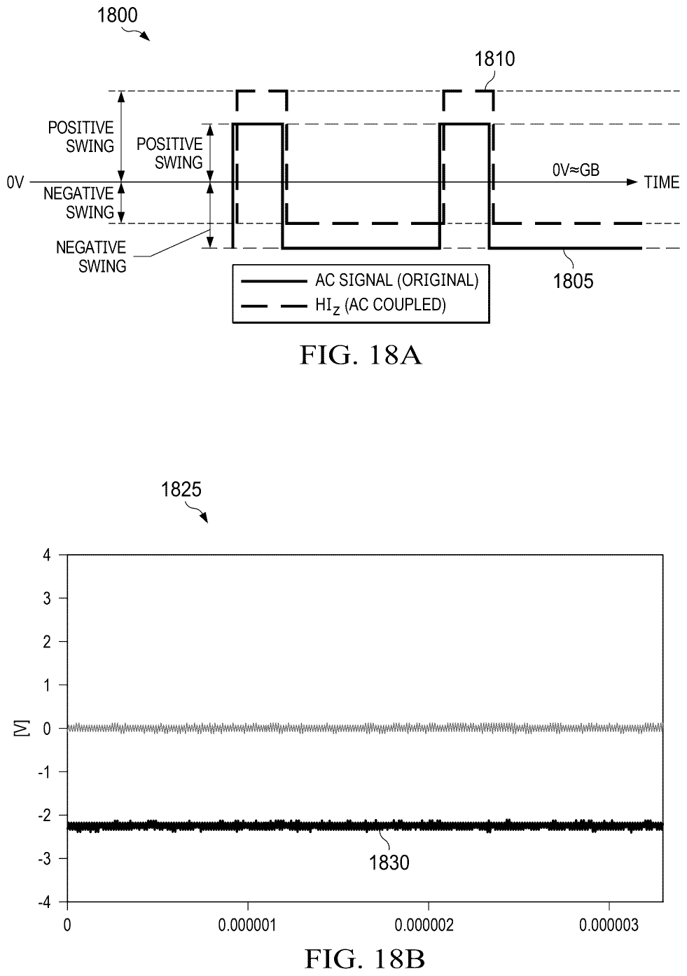

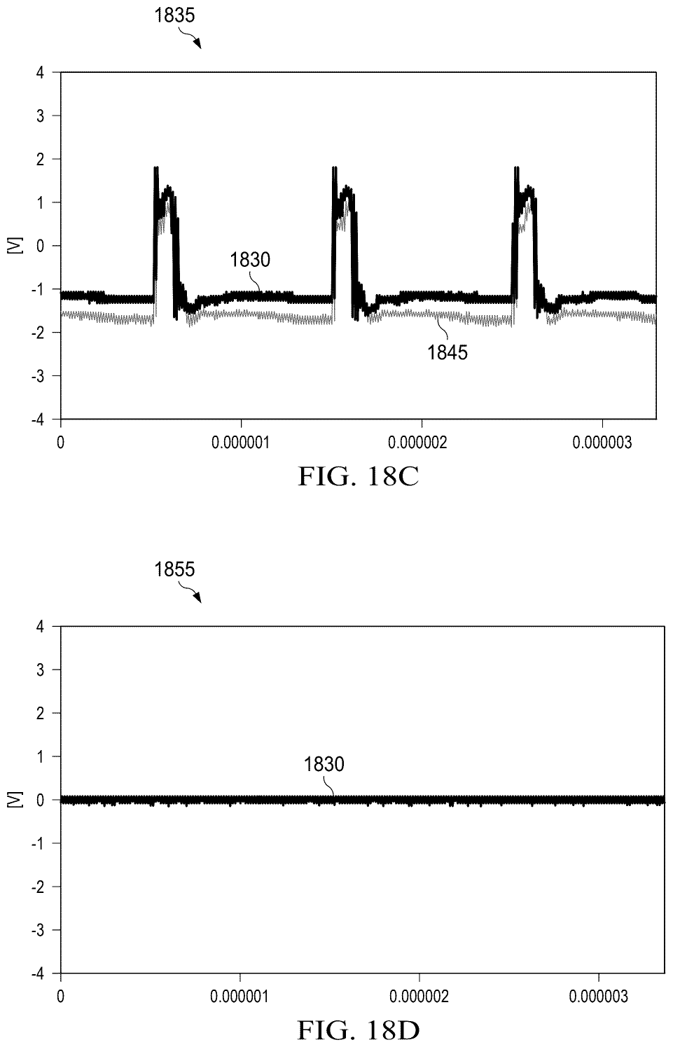

FIGS. 18A, 18B, 18C, and 18D are timing diagrams of example operations of the initialization circuitry 220 or more generally the AC compensated sense circuitry 1100 using a square waveform. FIG. 18A is a timing diagram 1800 of an example AC signal 1805 and an example high impedance coupled AC signal 1810. The AC signal 1805 represents the output of the AC source circuitry 425. In the examples of FIGS. 18A, 18B, 18C, 18D, and 18E, the AC signal 1805 is a square waveform. The high impedance coupled AC signal 1810 represents the portions of the AC signal 1805 at the high impedance input of the AC compensated sense circuitry 1100. For example, the high impedance coupled AC signal 1810 illustrates the AC signal 1805 after traversing at least the capacitors 230, 515 to the high impedance input of the AC compensated sense circuitry 1100.

In the example operations of FIGS. 18A, 18B, 18C, and 18D the high impedance coupled AC signal 1810 has a positive voltage swing (above the ground voltage) that is greater than a negative voltage swing (below the ground voltage). During example injection of the AC signal 1805, the diode circuitry 1110 supplies charge from a buffered ground to the first input of the AC compensated sense circuitry 1100 responsive to the positive voltage swing of the high impedance coupled AC signal 1810. Advantageously, injecting AC signals with positive voltage swings that are greater than negative voltage swings accounts for an accumulation of negative charges at the first input of the AC compensated sense circuitry 1100.

For example, the positive voltage swing of the high impedance coupled AC signal 1810 exceeds the threshold of the diode 1120 and the negative voltage swing of the high impedance coupled AC signal 1810 is less than the threshold of the diode 1130. In such examples, the high impedance coupled AC signal 1810 reduces negative charge accumulation responsive to the diode 1120 conducting a current exponentially greater than the diode 1130.

FIG. 18B is a timing diagram 1825 of an example output voltage 1830 and an example reference voltage (also referred to as a target voltage). The output voltage 1830 represents a voltage at the output of the AC compensated sense circuitry 1100. The reference voltage represents the target value of the output voltage 1830. The timing diagram 1825 illustrates the output voltage 1830 during pre-injection operations that occur before injecting the AC signal 1805. Prior to the example operations of the timing diagram 1825, an accumulation of positive charges at the high impedance input of the AC compensated sense circuitry 1100 occurs responsive to the measurement current supplying current to a high impedance terminal of the charge integrator circuitry 210. In such example operations, the capacitor 515 sets the output voltage 1830 to the low-side supply voltage (SUP-) of the amplifier circuitry 505.

FIG. 18C is a timing diagram 1835 of the output voltage 1830 and an example AC injection signal 1845 during an example injection of the AC signal 1805. The AC injection signal 1845 represents the output of the initialization circuitry 220 over time. In the example operations of the timing diagram 1835, which follow the operations of the timing diagram 1825, the positive voltage swing of the high impedance coupled AC signal 1810 drives charges, which set the output voltage 1830, from the AC injection signal 1845 through the diode circuitry 1110 to the first input of the AC compensated sense circuitry 1100. Advantageously, during the charge injection illustrated in the timing diagram 1835, supplying the AC signal 1805 to the capacitor 230 increases the output voltage 1830 by causing negative charges from the guard buffer circuitry 250 to compensate for accumulated negative charge at the first input of the AC compensated sense circuitry 1100.

FIG. 18D is a timing diagram 1855 of the output voltage 1830 and the AC injection signal 1845 after the injection of the AC signal 1805. In the example operations of the timing diagram 1855, the initialization circuitry 220 no longer injects the AC signal 1805. In some examples, the initialization circuitry 220 may continue to inject the AC signal 1805 for a duration of time after being equal to the reference voltage, which is approximately zero volts. In some examples, the AC signal 1805 allows the AC compensated sense circuitry 1100 to start integration operations at a non-zero output voltage. In such examples, the non-zero output voltage allows the AC Compensated sense circuitry 1100 to account for dielectric relaxation responsive to having a zero crossing when supplying the AC signal 1805. For example, the dielectric relaxation begins to compound as the output voltage 1830 increases responsive to the derivative of the output voltage 1830 compounding as a leakage current. However, the leakage current across the capacitor 515 is substantially smaller when the output voltage 1830 is near zero. Advantageously, the zero crossing during AC integration ensures that the voltage difference across the integrating capacitor crosses zero volts. Advantageously, setting the voltage across the integrating capacitor to zero reduces the leakage current, which reduces measurement errors resulting from dielectric relaxation. Advantageously, the AC compensated sense circuitry 1100 may begin to accurately sense the measurement current at the first input after the operations of timing diagrams 1825, 1835, 1850. Advantageously, the AC compensated sense circuitry 1100 has a higher accuracy responsive to the AC injection of the AC signal 1805 removing charges across the capacitor 515.

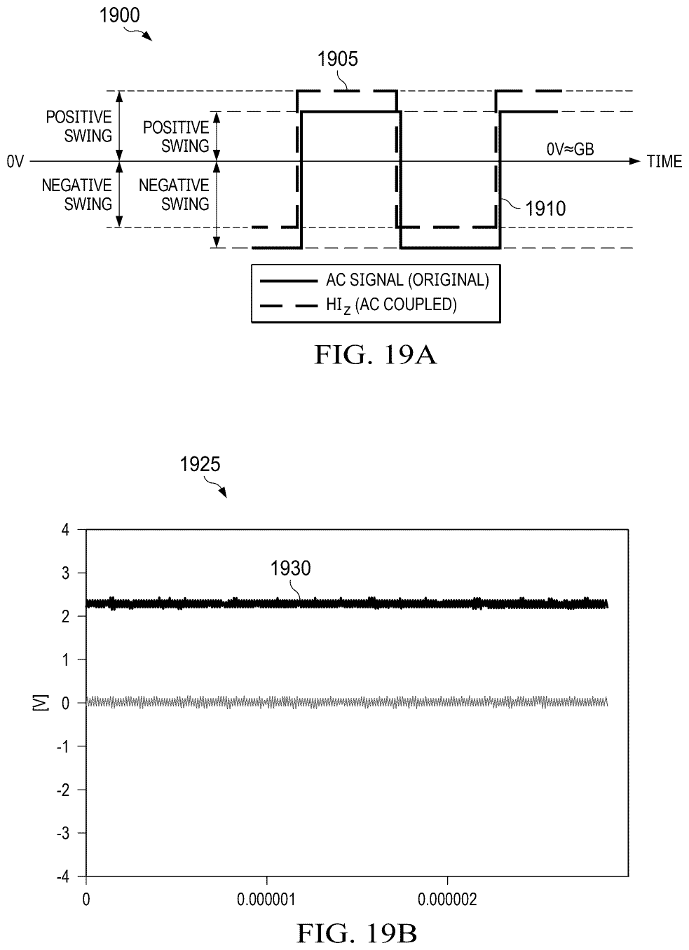

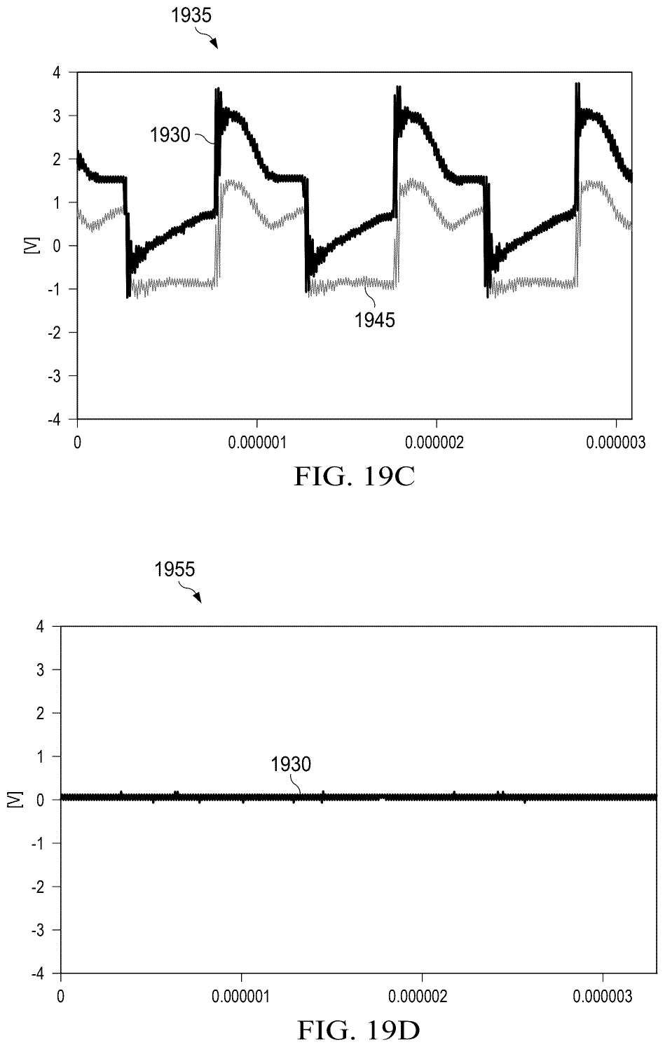

FIGS. 19A, 19B, 19C, and 19D are timing diagrams of example operations of the initialization circuitry 220 or more generally the AC compensated sense circuitry 1100 using a square waveform. FIG. 19A is a timing diagram 1900 of an example AC signal 1905 and an example high impedance coupled AC signal 1910. The AC signal 1905 represents the output of the AC source circuitry 535. In the examples of FIGS. 19A, 19B, 19C, 19D, and 19E, the AC signal 1905 is a square waveform. In other examples, such as FIGS. 15A, 16A, and 17A, the AC signal 1905 may be an alternative waveform. The high impedance coupled AC signal 1910 represents the portions of the AC signal 1905 at the high impedance input of the AC compensated sense circuitry 1100. For example, the high impedance coupled AC signal 1910 illustrates the AC signal 1905 after traversing at least the capacitors 230, 515 to the first input of the AC compensated sense circuitry 1100.

In the example operations of FIGS. 19A, 19B, 19C, and 19D the high impedance coupled AC signal 1910 has a negative voltage swing (below the ground voltage) that is greater than a positive voltage swing (above the ground voltage). During example injection of the AC signal 1905, accumulated charges at the first input of the AC compensated sense circuitry 1100 flow through the diode circuitry 1110 to ground responsive to the negative voltage swing of the high impedance coupled AC signal 1910. For example, the negative voltage swing of the high impedance coupled AC signal 1910 exceeds the threshold of the diode 1130 and the positive voltage swing of the high impedance coupled AC signal 1910 is less than the threshold of the diode 1120. In such examples, the high impedance coupled AC signal 1910 reduces positive charge accumulation responsive to the diode 1130 conducting a current exponentially greater than the diode 1120.

FIG. 19B is a timing diagram 1925 of an example output voltage 1930 and an example reference voltage (also referred to as a target voltage). The output voltage 1930 represents a voltage at the output of the AC compensated sense circuitry 1100. The reference voltage represents the target voltage of the output voltage 1930, which is approximately equal to zero volts. The timing diagram 1925 illustrates the output voltage 1930 during pre-injection operations, which occur before injecting the AC signal 1905. Prior to the example operations of the timing diagram 1925, an accumulation of charges at the high impedance input of the AC compensated sense circuitry 1100 occurs responsive to the measurement current sinking current from a high impedance terminal of the charge integrator circuitry 210. In such example operations, the capacitor 515 sets the output voltage 1930 to the high-side supply voltage (SUP+) of the amplifier circuitry 505.

FIG. 19C is a timing diagram 1935 of the output voltage 1930 and an example AC injection signal 1945 during an example injection of the AC signal 1905. The AC injection signal 1945 represents the output of the initialization circuitry 220 over time. In the example operations of the timing diagram 1935, which follow the operations of the timing diagram 1925, the negative voltage swing of the high impedance coupled AC signal 1910 drives charges, which set the output voltage 1930, through the diode circuitry 1110 to the reference voltage, which is approximately zero volts. Advantageously, during the charge injection illustrated in the timing diagram 1935, supplying the AC signal 1905 to the capacitor 230 decreases the output voltage 1930 by causing an accumulation of charges at the high impedance input of the AC compensated sense circuitry 1100.

FIG. 19D is a timing diagram 1955 of the output voltage 1930 and the AC injection signal 1945 after the injection of the AC signal 1905. In the example operations of the timing diagram 1955, the initialization circuitry 220 no longer injects the AC signal 1905. In some examples, the initialization circuitry 220 may continue to inject the AC signal 1905 for a duration of time after being equal to the reference voltage, which is approximately zero volts. In some examples, the AC signal 1905 allows the AC compensated sense circuitry 1100 to start integration operations at a non-zero output voltage. In such examples, the non-zero output voltage allows the AC Compensated sense circuitry 1100 to account for dielectric relaxation responsive to having a zero crossing when supplying the AC signal 1905. For example, the dielectric relaxation begins to compound as the output voltage 1930 increases responsive to the derivative of the output voltage 1930 compounding as a leakage current. However, the leakage current across the capacitor 515 is substantially smaller when the output voltage 1930 is near zero. Advantageously, the zero crossing during AC integration ensures that the voltage difference across the integrating capacitor crosses zero volts. Advantageously, setting the voltage across the integrating capacitor to zero reduces the leakage current, which reduces measurement errors resulting from dielectric relaxation. Advantageously, the AC compensated sense circuitry 1100 may begin to accurately sense the measurement current at the first input after the operations of timing diagrams 1925, 1935, 1950. Advantageously, the AC compensated sense circuitry 1100 has a higher accuracy responsive to the AC injection of the AC signal 1905 removing charges across the capacitor 515.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and things, the phrase “at least one of A and B” refers to implementations including any of (1) at least one A, (2) at least one B, or (3) at least one A and at least one B. Similarly, as used herein in the context of describing structures, components, items, objects and things, the phrase “at least one of A or B” refers to implementations including any of (1) at least one A, (2) at least one B, or (3) at least one A and at least one B. As used herein in the context of describing the performance or execution of processes, instructions, actions, activities, etc., the phrase “at least one of A and B” refers to implementations including any of (1) at least one A, (2) at least one B, or (3) at least one A and at least one B. Similarly, as used herein in the context of describing the performance or execution of processes, instructions, actions, activities, etc., the phrase “at least one of A or B” refers to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or actions may be implemented by, e.g., the same entity or object. Also, although individual features may be included in different examples or claims, these may possibly be combined, and the inclusion in different examples or claims does not imply that a combination of features is at least one of not feasible or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by at least one of the connection reference or relative movement between those elements unless otherwise indicated. As such, connection references do not necessarily infer that two elements are directly connected or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, or ordering in any way, but are merely used as at least one of labels or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to at least one of manufacturing tolerances or other real-world imperfections. For example, “approximately” and “about” may indicate such dimensions may be within a tolerance range of +/−10% unless otherwise specified herein.

As used herein, the phrase “in communication,” including variations thereof, encompasses one of or a combination of direct communication or indirect communication through one or more intermediary components, and does not require direct physical (e.g., wired) communication or constant communication, but rather also includes selective communication at least one of periodic intervals, scheduled intervals, aperiodic intervals, or one-time events.

As used herein, “programmable circuitry” is defined to include at least one of (i) one or more special purpose electrical circuits (e.g., an application specific circuit (ASIC)) structured to perform specific operation(s) and including one or more semiconductor-based logic devices (e.g., electrical hardware implemented by one or more transistors), or (ii) one or more general purpose semiconductor-based electrical circuits programmable with instructions to perform one or more specific functions(s) or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations or functions, Field Programmable Gate Arrays (FPGAs) that may be programmed with second instructions to at least one of configure or structure the FPGAs to instantiate one or more operations or functions corresponding to the first instructions, Graphics Processor Units (GPUs) that may execute first instructions to perform one or more operations or functions, Digital Signal Processors (DSPs) that may execute first instructions to perform one or more operations or functions, XPUs, Network Processing Units (NPUs) one or more microcontrollers that may execute first instructions to perform one or more operations or functions or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., at least one of programmed or hardwired) at a time of manufacturing by a manufacturer to at least one of perform the function or be configurable (or re-configurable) by a user after manufacturing to perform the function /r other additional or alternative functions. The configuring may be through at least one of firmware or software programming of the device, through at least one of a construction or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

In the description and claims, described “circuitry” may include one or more circuits. A circuit or device that is described herein as including certain components may instead be adapted to be coupled to those components to form the described circuitry or device. For example, a structure described as including one or more semiconductor elements (such as transistors), one or more passive elements (such as one of or a combination of resistors, capacitors, or inductors), or one or more sources (such as voltage and/or current sources) may instead include only the semiconductor elements within a single physical device (e.g., at least one of a semiconductor die or integrated circuit (IC) package) and may be adapted to be coupled to at least some of the passive elements or the sources to form the described structure either at a time of manufacture or after a time of manufacture, for example, by at least one of an end-user or a third-party.

Circuits described herein are reconfigurable to include the replaced components to provide functionality at least partially similar to functionality available prior to the component replacement. Components shown as resistors, unless otherwise stated, are generally representative of any one or more elements coupled in at least one of series or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and some features illustrated as being internal to the integrated circuit may be incorporated outside of the integrated. As used herein, the term “integrated circuit” means one or more circuits that are at least one of: (i) incorporated in/over a semiconductor substrate; (ii) incorporated in a single semiconductor package; (iii) incorporated into the same module; or (iv) incorporated in/on the same printed circuit board.

Uses of the phrase “ground” in the foregoing description include at least one of a chassis ground, an Earth ground, a floating ground, a virtual ground, a digital ground, a common ground, or any other form of ground connection applicable to, or suitable for, the teachings of this description. Unless otherwise stated, “about,” “approximately,” or “substantially” preceding a value means +/−10 percent of the stated value, or, if the value is zero, a reasonable range of values around zero.

Modifications are possible in the described embodiments, and other embodiments are possible, within the scope of the claims.

What is claimed is:

1. An apparatus comprising:
alternating current (AC) source circuitry having an input and an output;
comparator circuitry having an input and an output, the output of the comparator circuitry coupled to the input of the AC source circuitry;
integrator circuitry having an output of the integrator circuitry coupled to the input of the comparator circuitry; and
a capacitor having a first terminal and a second terminal, the first terminal of the capacitor coupled to the output of the AC source circuitry, the second terminal of the capacitor coupled to the integrator circuitry.

2. The apparatus of claim 1, wherein the capacitor is a first capacitor, and the integrator circuitry further includes:
amplifier circuitry having an input and an output;
a resistor having a first terminal and a second terminal, the first terminal of the resistor is coupled to the output of the amplifier circuitry; and
a second capacitor having a first terminal and a second terminal, the first terminal of the second capacitor is coupled to the input of the comparator circuitry, the second terminal of the first capacitor, and the second terminal of the resistor, the second terminal of the second capacitor is coupled to the input of the amplifier circuitry.

3. The apparatus of claim 1, wherein the integrator circuitry further has an input, of the further comprising:
a first diode having a first terminal and a second terminal; and
a second diode having a first terminal and a second terminal, the first terminal of the second diode is coupled to the input of the integrator circuitry and the first terminal of the first diode, the second terminal of the second diode is coupled to the second terminal of the first diode.

4. The apparatus of claim 3, wherein the integrator circuitry further has a second input, and the apparatus further comprising buffer circuitry having an input and an output, the input of the buffer circuitry is coupled to the second input of the integrator circuitry, the output of the buffer circuitry is coupled to the second terminal of the first diode and the second terminal of the second diode.

5. The apparatus of claim 3, wherein the second terminal of the capacitor is coupled to the second terminal of the first diode and the second terminal of the second diode.

6. An apparatus comprising:
amplifier circuitry having an input and an output;
a first diode having a first terminal and a second terminal;
a second diode having a first terminal and a second terminal, the first terminal of the second diode coupled to the first terminal of the first diode;
a first capacitor having a first terminal and a second terminal, the first terminal of the first capacitor is coupled to the input of the amplifier circuitry, the second terminal of the first diode, and the second terminal of the second diode; and
a second capacitor having a terminal coupled to the output of the amplifier circuitry and the second terminal of the first capacitor.

7. The apparatus of claim 6, wherein the terminal of the second capacitor is a first terminal, the second capacitor further has a second terminal, and the apparatus further comprising alternating current (AC) source circuitry having an output coupled to the second terminal of the second capacitor.

8. The apparatus of claim 7, wherein the AC source circuitry further has an input, and the apparatus further comprising comparator circuitry having an input and an output, the input of the comparator circuitry is coupled to the output of the amplifier circuitry, the second terminal of the first capacitor, and the first terminal of the second capacitor, the output of the comparator circuitry is coupled to the input of the AC source circuitry.

9. The apparatus of claim 6, wherein the amplifier circuitry is first amplifier circuitry, the input of the first amplifier circuitry is a first input, the first amplifier circuitry further has a second input, and the apparatus further comprising second amplifier circuitry having an input and an output, the input of the second amplifier circuitry is coupled to the second input of the first amplifier circuitry, the output of the second amplifier circuitry is coupled to the second terminal of the first diode and the second terminal of the second diode.

10. The apparatus of claim 6, wherein the amplifier circuitry is first amplifier circuitry, the apparatus further comprising second amplifier circuitry having an input and an output, the input of the second amplifier circuitry is coupled to the input of the first amplifier circuitry and the first terminal of the first capacitor, the output of the second amplifier circuitry is coupled to the second terminal of the first diode and the second terminal of the second diode.

11. An apparatus comprising:
amplifier circuitry having an input and an output;
a first diode having a first terminal and a second terminal;
a second diode having a first terminal and a second terminal;
a first capacitor having a first terminal and a second terminal, the first terminal of the first capacitor coupled to the input of the amplifier circuitry, the first terminal of the first diode, and the first terminal of the second diode, the second terminal of the first capacitor coupled to the output of the amplifier circuitry; and
a second capacitor having a terminal coupled to the second terminal of the first diode and the second terminal of the second diode.

12. The apparatus of claim 11, further comprising comparator circuitry having an input coupled to the output of the amplifier circuitry and the second terminal of the first capacitor.

13. The apparatus of claim 12, wherein the terminal of the second capacitor is a first terminal, the second capacitor further comprising a second terminal, the comparator circuitry further has an output, and the apparatus further comprising alternating current (AC) source circuitry having an input and an output, the input of the AC source circuitry is coupled to the output of the comparator circuitry, the output of the comparator circuitry is coupled to the second terminal of the second capacitor.

14. The apparatus of claim 11, wherein the amplifier circuitry is first amplifier circuitry, the input of the first amplifier circuitry is a first input, the first amplifier circuitry further has a second input, and the apparatus further comprising second amplifier circuitry having an input and an output, the input of the second amplifier circuitry is coupled to the second input of the first amplifier circuitry, the output of the second amplifier circuitry is coupled to the second terminal of the first diode, the second terminal of the second diode, and the terminal of the second capacitor.

15. The apparatus of claim 11, wherein the amplifier circuitry is first amplifier circuitry, the apparatus further comprising second amplifier circuitry having an input and an output, the input of the second amplifier circuitry is coupled to the input of the first amplifier circuitry and the first terminal of the first capacitor, the output of the second amplifier circuitry is coupled to the second terminal of the first diode, the second terminal of the second diode, and the terminal of the second capacitor.

16. An apparatus comprising:
integrator circuitry having an output;
a capacitor coupled to the integrator circuitry, the capacitor having a terminal; and
comparator circuitry coupled to the output of the integrator circuitry and having an output, the comparator circuitry configured to compare an output voltage of the integrator circuitry to a reference voltage; and
alternating current (AC) source circuitry coupled to the integrator circuitry, having an input coupled to the output of the comparator circuitry, and having an output coupled to the terminal of the capacitor, the AC source circuitry configured to provide an AC signal responsive to the comparison of the output voltage to the reference voltage.

17. The apparatus of claim 16, further comprising diode circuitry coupled to the integrator circuitry, the diode circuitry configured to provide a current path from the input of the integrator circuitry to ground.

18. The apparatus of claim 17, further comprising guard buffer circuitry coupled to the integrator circuitry and the diode circuitry, the guard buffer circuitry configured to isolate the ground from currents of the diode circuitry.

19. The apparatus of claim 16, wherein the AC source circuitry is further configured to:
generate the AC signal responsive to a reset indication; and
modify the output voltage of the integrator circuitry responsive to supplying the AC signal to the capacitor.

20. The apparatus of claim 16, wherein the AC source circuitry is further configured to at least one of:
decrease a positive charge accumulation at the input of the integrator circuitry responsive to a negative voltage swing of the AC signal being greater than a positive voltage swing of the AC signal; and
increase a negative charge accumulation at the input of the integrator circuitry responsive to the negative voltage swing of the AC signal being less than the positive voltage swing of the AC signal.
